(19) United States
(12) Patent Application Publication
(10) Pub. No.: US 2011/0288938 A1
(43) Pub. Date: Nov. 24, 2011

(54) INTERACTIVE DISPLAY SYSTEM

(75) Inventors: Gary W. Cook, Beatrice, NE (US); Mark Patterson, Beatrice, NE (US)

(73) Assignee: STORE KRAFT, Beatrice, NE (US)

(21) Appl. No.: 13/196,549

(22) Filed: Aug. 2, 2011

Related U.S. Application Data
(63) Continuation of application No. 12/797,245, filed on Jun. 9, 2010.
Application No. 12/797,245 is a continuation of application No. 12/290,209, filed on Oct. 28, 2008, now abandoned.
Application No. 12/290,209 is a continuation of application No. 12/008,713, filed on Jan. 11, 2008, now abandoned.
(60) Provisional application No. 61/220,065, filed on Jun. 24, 2009.
(60) Provisional application No. 60/904,595, filed on Mar. 2, 2007.

(51) Int. Cl. G06Q 30/00; G08B 13/14

(52) U.S. Cl. 705/14.66; 340/572.1; 705/14.49; 705/27.2

(57) ABSTRACT

The present disclosure is directed to a multiple security level display apparatus. The display apparatus may comprise a storage area; a display area adjoining the storage area; a product exhibit device for supporting at least one product, the product exhibit device being movable between a display position at least substantially within the display area, and a storage position within the storage area; a consumer-product interface for temporarily receiving at least one product removed from the product exhibit device; a movable storage area cover for separating the display area and the storage area; and a digital identification system configure for at least one of: controlling access to the display area; controlling a position of the product exhibit device; conducting an inventory including the at least one product; and monitoring a proximity of the at least one product.

### CROSS REFERENCE TO RELATED APPLICATIONS

Noon The present application is a continuation of U.S. patent application Ser. No. 12/797,245 filed Jun. 9, 2010, which claims the benefit under 35 U.S.C. §119(e) of U.S. Provisional Application Ser. No. 61/220,065, filed Jun. 24, 2009. The present application is a continuation of U.S. patent application Ser. No. 12/290,209 filed Oct. 28, 2008, which claims the benefit under 35 U.S.C. §119(e) of U.S. Provisional Application Ser. No. 60/904,595, filed Mar. 2, 2007. The present application is a continuation of U.S. patent application Ser. No. 12/008,713 filed Jan. 11, 2008, which claims the benefit under 35 U.S.C. §119(e) of U.S. Provisional Application Ser. No. 60/904,595, filed Mar. 2, 2007. U.S. patent application Ser. Nos. 12/797,245, 12/290,209, and 12/008,713 and U.S. Provisional Application Ser. Nos. 61/220,065 and 60/904,595 are herein incorporated by reference in their entirety.

### TECHNICAL FIELD

The disclosure generally relates to the field of interactive product displays, particularly to an interactive product display for inventory and shopper monitoring, such as a smart shelf, and more particularly to a secure, shopper self-assistance kiosk for interactively displaying products.

### BACKGROUND OF THE INVENTION

During the sale of products, such as fragrances, jewelry, handbags and the like, fixtures are employed by retailers to allow viewing of products by shoppers while maintaining secure storage of the products. A conventional fixture may include a base, constructed of rigid materials such as wood, metal and the like. A fixture may also include one or more display assemblies, such as shelves, mounted to the base for the display of products for sale. Some fixtures may also include a transparent shield or cover, mounted to the base of the fixture. The transparent cover may be constructed of glass, plastic and the like to allow a shopper to view products while preventing a shopper from accessing the product without assistance from a salesperson. When products are placed within fixtures, including a transparent shield, theft of the products may be deterred.

During the sale of products, such as fragrances, jewelry, handbags and the like, fixtures are employed by retailers to allow viewing of products by shoppers while maintaining secure storage of the products. A conventional fixture may include a base, constructed of rigid materials such as wood, metal and the like. A fixture may also include one or more display assemblies, such as shelves, mounted to the base for the display of products for sale. Some fixtures may also include a transparent shield or cover, mounted to the base of the fixture. The transparent cover may be constructed of glass, plastic and the like to allow a shopper to view products while preventing a shopper from accessing the product without assistance from a salesperson.

### SUMMARY OF THE INVENTION

The present invention is directed to a secure, shopper self-assistance kiosk for interactively displaying products and/or product information to potential product shoppers without requiring sales associate intervention. It is generally recognized that shoppers positioned near goods for sale have some level of interest in the displayed products for sale. Sales associates must be careful in how, when and if to approach shoppers observed near goods for sale. This is true since it is difficult to ascertain a shopper's level of interest from simple observation. Ready-shoppers are those shoppers that know what they want and are ready to purchase. A ready-shopper will grow frustrated if assistance is not offered quickly. Likewise, some shoppers are need-information-before-purchasing-shoppers.

Need-information-before-purchasing-shoppers have decided to make a purchase but need at least one of selection, pricing, options, availability, or suitability questions answered before making a purchase. It is recognized by those skilled in the art, that need-information-before-purchasing-shoppers will grow frustrated if knowledgeable assistance is not offered quickly.

Only-looking-shoppers may become shoppers under certain not well understood circumstances. Shoplifters are individuals disguised as shoppers that are either intending to steal goods or willing to steal goods if a low risk opportunity to steal goods is made available. The ability to first ascertain and then provide the level and type of assistance a shopper desires is a valued sales associate skill.

The secure, shopper self-assistance kiosk of the present invention may be useful in ameliorating staffing difficulties. Ascertaining and then maintaining the correct number of sales associates with the necessary skill and product knowledge is difficult. For example, while shoppers tend to shop at generally predictable times, they periodically and sporadically arrive when sufficient sales associates are unavailable. This is problematic since sales associates may be busy assisting shoppers of other goods, leaving ready shoppers of higher margin goods waiting. Rushed sales associates and shoppers produce less than ideal sales experiences. Inappropriate sales associate utilization, under-staffing or the presence of unknowledgeable sales associates also negatively impacts need-information-before-purchasing-shoppers. Many need-information-before-purchasing-shoppers need time to handle merchandise while formulating questions regarding suitability and options. In rushed or less than ideal circumstances, these potential shoppers may receive incorrect or incomplete information about a product, make a lower margin value purchase (which may not include additional higher margin accessories), or simply go elsewhere.

The secure, shopper self-assistance kiosk of the present invention also provides product theft security without offending shoppers or minimizing shopper access to goods for sale. Those skilled in the art have employed a number of novel methods and apparatus for limiting theft. In the past, theft deterrent features tended to reduce or limit product access without providing any shopper assistance. Oftentimes, these security measures have become sales barriers because shoppers like to handle and try goods they are interested in purchasing. This is especially true of high cost fashion accessories such as belts, eyeglass and sunglass frames, watches, jewelry, handbags, winter apparel, perfume and the like, as well as portable electronic devices such as wireless telephones, personal data assistants, cameras, and the like. These items are also primary targets for shoplifters disguised as shoppers. For this reason many retailers and the like maintain such items in a locked display. A potential shopper must have a high level of interest to even look into the display, let alone to await assistance. The present invention adds new, novel and non-obvious theft prevention with purchase inducement features. A small security tag may be placed on each product displayed allowing each tagged product to be actively monitored by the secure, shopper self-assistance kiosk. The small security tag is remotely connected to the present invention and thus may allow precise monitoring of the tagged item. If a shopper touches a tagged item the system records the time, location, and other element information. If a shopper takes a tagged item out of range of the present invention, an alarm will sound. Furthermore, if a shopper attempts to remove the security tag, the tag will be destroyed and an alarm will be triggered. The sophistication of this technology eliminates the need to place expensive products under lock and key. Thus, the merchandise may be secured and the shopper may freely interact with a displayed product. Additionally, the tags may be designed to not detract from either the appearance or intractability of a shopper with a tagged item.

The secure, shopper self-assistance kiosk of the present invention also allows more shoppers per unit of time to enjoy a fuller, more satisfying shopping experience. It is common for retail stores to have an insufficient staff to accommodate potential shoppers. Additionally, before purchasing high cost fashion or electronic items, potential shoppers need to feel confident that the purchase they are considering is a good investment. A sales associate is an integral part of the purchasing process, as they provide access and information about the products for sale. Shoppers are often put-off in these situations, many times worrying that a sales associate may be: (a) busy helping others, (b) have little product knowledge, or (c) will have or maintain a hurried, ambivalent or superior attitude. This makes potential shoppers feel uncomfortable and creates an unwelcoming purchasing environment. Such situations make shopping for high priced items inconvenient and frustrating; thus, a shopper is likely to keep walking rather than make a purchase. The present invention provides a solution to this problem by allowing a shopper to fully interact with the product in a semi-private environment, away from the apparent scrutiny of sales associates. Further, the present invention fosters a more positive purchasing environment by removing barriers caused by uninformed or disrespectful sales associates. In this way, a shopper is more likely to feel good about her purchase, thus being less likely to seek to return or exchange a purchased item. Returns or exchanges are expensive, drain resources, and ultimately result in, at best, an overall neutral or slightly negative shopper experience (due to multiple trips, waiting in line, saving receipts, tarnished or opened packaging, torn labels, physical damage and the like).

The secure, shopper self-assistance kiosk of the present invention allows product interaction while providing a shopper with product information. Under current shopping conditions it is difficult to convey product information to potential shoppers because sales associates may be poorly trained or unable to fully convey the quality of high fashion items and/or the sophisticated nature of electronic items. The ability to educate shoppers regarding the distinguishable advantages of high cost fashion and electronic items is essential to convincing shoppers to buy these products instead of comparable, less expensive items. The present invention provides a solution to the problem by having an interactive display which contains specific information about the displayed products. This feature is particularly useful for need-information-before-purchasing-shoppers, who have specific questions and concerns that need to be satisfactorily addressed in order to secure a sale. Thus, an interested shopper may learn about various products, product features, try products, and make product comparisons. Additionally, a shopper may determine product availability, options, accessories, and pricing. Also anticipated and included in further embodiments of the present invention are the ability of the shopper to print or email a photograph of the shopper with the product, said print or email further including information about the product and related products. Additionally, a shopper may have comparison photographs taken with different products (e.g., in columnar format) printed or emailed for later review or for input from friends, family and the like.

The secure, shopper self-assistance kiosk of the present invention also allows a shopper to request assistance from sales associates, or if desired, to purchase and obtain product without the assistance of sales associates. Multiple shoppers may be served simultaneously by the present invention. In such an embodiment multiple kiosk surfaces or remote panels may be employed. This feature increases store efficiency and overall shopper satisfaction by encouraging shoppers to choose the level of interaction they have with sales associates. Both ready-shoppers and only-looking-shoppers will greatly benefit from this aspect of the invention because each category of shoppers has different sets of expectations regarding sales associate interaction. Ready-shoppers may select the item or items they wish to purchase and complete the transaction using the present invention's automated payment system. Only-looking-shoppers may browse through the displayed products, be provided with product information and use the remote call feature of the present invention to request a sales associate's assistance if desired.

The secure, shopper self-assistance kiosk of the present invention may have the ability to increase product sales by attracting shoppers with its high-tech, interactive display. The interactive display may have the ability to monitor traffic around the kiosk, triggering a variety of sensory advertising techniques as potential shoppers approach. The present invention may also be capable of quickly coming in and out of hibernation, decreasing the retailer's overhead costs by only using energy when shoppers are within certain proximity.

The secure, shopper self-assistance kiosk of the present invention may include a fitting mirror which would allow a shopper to try on a product or a multitude of products in order to experience the look and feel of the items for sale. This feature is particularly important in the sale of high cost fashion items, such as belts, eyeglass and sunglass frames, watches, jewelry, handbags, winter apparel, perfume and the like. Potential shoppers are interested in the look and feel of these high cost fashion items and are more apt to purchase them if they have the opportunity to sufficiently inspect these items. The presence of a small security tag on displayed items ensures the security of high cost fashion items while facilitating maximum interaction with said items. Thus, an interested shopper can try on one or more products in order to evaluate qualities such as size, color, and feel, among other things, to determine if it appealing while it is worn. This aspect of the present invention is also useful for shoppers purchasing multiple items or who would purchase multiple items under favorable marketing conditions. In the present invention, the fitting mirror is positioned closely to high cost items coupled with the small security tags, which encourages a shopper to try on multiple items simultaneously. The interactive display suggests complementary items, increasing the likelihood that the shopper will purchase multiple items. This feature is useful to shoppers who are interested in coordinating fashion items and is beneficial to the company, which obtains additional revenue from increased sales.

The secure, shopper self-assistance kiosk of the present invention may include a modular display comprised of parts which can be easily rearranged, removed and/or replaced. Such an embodiment allows parts to be rearranged to accommodate changing product displays. This feature also eliminates the need for specially trained maintenance professionals to repair the modular display. Because the modular display's component parts can be easily removed, a sales associate may simply order a replacement part and fix the display. This feature ensures the present invention will have minimal downtime because displays can be rearranged and parts can be changed quickly.

The secure, shopper self-assistance kiosk of the present invention may track inventory in real time using small security tags placed on the products. This feature may provide descriptive information about each security tagged product and may generate, store, and/or analyze said information. Additionally, this feature may allow the company to track if a security tagged product has been misplaced, purchased, moved, picked up and not purchased, out of stock, low on stock, overstocked, selected, and/or inquired about. This feature may be further utilized to locate inventory, recall defective inventory, and/or provide instant price changes.

The secure, shopper self-assistance kiosk of the present invention may provide the retailer with product or merchandising intelligence. The interactive display may have the ability to track the number of times an item is picked-up, purchased, and/or returned. This feature may also create and manage shopper profiles, track peak purchase times, monitor the effectiveness of promotional events, record inventory turnover, collect shopper product suggestions and measure the amount of time a shopper spends looking at an item, among other things. This data will be invaluable to the retailer's marketing department, which may use the data to more effectively reach their target shoppers.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

The present disclosure is directed to a multiple security level display apparatus. The display apparatus may comprise a storage area defined by a plurality of side walls; a display area adjoining the storage area, the display area including at least one door for accessing the display area; a product exhibit device for supporting at least one product, the product exhibit device being movable between a display position at least substantially within the display area, and a storage position within the storage area; a consumer-product interface for temporarily receiving at least one product removed from the product exhibit device; a movable storage area cover for separating the display area and the storage area; and a digital identification system configured for at least one of: controlling access to the display area through the at least one door; controlling a position of the product exhibit device; conducting an inventory including the at least one product; and monitoring a proximity of the at least one product, where said product is at least one of on said product exhibit device, on said consumer-product interface, or not on either of said product exhibit device or consumer-product interface.

A further embodiment of the present disclosure is directed to a system. The system may comprise a storage unit having a product exhibit device, where the product exhibit device has a storage position and a display position; a consumer-product interface for temporarily receiving at least one product from the product exhibit device; a digital identification receiver communicatively coupled to the storage unit and the consumer-product interface, where the digital identification receiver is configured for receiving radio frequency signals; and a control program operating in response to the digital identification receiver, wherein the control program is configured for at least one of: controlling a position of the product exhibit device; controlling access to the product exhibit device when the product exhibit device is in the display position; conducting an inventory including the at least one product; and monitoring a location for the at least one product where said product is at least one of in said storage unit, on said consumer-product interface, or not in either of said storage unit or consumer-product interface.

An additional embodiment of the present disclosure is directed to a method. The method may comprise storing an article in a storage unit having a product exhibit device, where the product exhibit device has a storage position and a display position; placing the article on a consumer-product interface; receiving radio frequency signals at a digital identification receiver communicatively coupled to the storage unit and the consumer-product interface; and operating a control program in response to the digital identification receiver, wherein the control program is configured for at least one of: controlling a position of the product exhibit device; controlling access to the product exhibit device when the product exhibit device is in the display position; conducting an inventory including the at least one article; and monitoring a location for the at least one article, where said article is at least one of in said storage unit, in said consumer-product interface, or not in either of said storage unit or consumer-product interface.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A is an isometric view illustrating an interactive display system;

FIG. 1B is a schematic diagram illustrating an interactive display system;

FIG. 1C is an isometric view illustrating a plurality of shelving units in an interactive display system;

FIG. 2 is a partial view illustrating a shelving unit of an interactive display system;

FIG. 3 is a partial view illustrating a shelving unit of an interactive display system, wherein a touch screen display is utilized by a shopper;

FIG. 4 is a partial view illustrating a shelving unit of an interactive display system, wherein the shelving unit comprises locked automatically locking drawers;

FIG. 5 is a partial view illustrating a shelving unit of an interactive display system, wherein the shelving unit comprises unlocked automatically locking drawers;

FIG. 6 is a block diagram illustrating a decision process for registering an RFID tagged product to a shelving unit;

FIG. 7 is a block diagram illustrating a method for monitoring RFID tagged product by a shelving unit;

FIG. 8 is a block diagram illustrating a safe zone process;

FIG. 9 is a block diagram illustrating an alert process;

FIG. 10 is a block diagram illustrating a mirror process;

FIG. 11 is a partial view illustrating a shelving unit of an interactive display system;

FIG. 12 is a partial view illustrating a shelving unit of an interactive display system, wherein a two-way mirror is utilized by a shopper;

FIG. 13 is a partial view illustrating a shelving unit of an interactive display system, wherein a touch screen display is utilized by a shopper;

FIG. 14 is an isometric view illustrating a shelving unit of an interactive display system, wherein the shelving unit comprises an access panel;

FIG. 15 is an isometric view illustrating a shelving unit of an interactive display system, wherein the shelving unit comprises a two-way mirror;

FIG. 16 is an isometric view illustrating an interactive display system, wherein the interactive display system comprises a two-way mirror;

FIG. 17 is a cross-sectional side view illustrating an interactive display system, wherein the interactive display system comprises a display, an RFID reader, a processing unit, a memory, and a power supply;

FIG. 18 is an isometric view illustrating an interactive display system, wherein the interactive display system comprises a two-way mirror;

FIG. 19 is an isometric view illustrating an interactive display system, wherein the interactive display system comprises an access panel;

FIG. 20 is an isometric view illustrating an interactive display system; FIG. 21 is a partial view illustrating a shelving unit of an interactive display system, wherein the shelving unit comprises unlocked automatically locking drawers utilized by a shopper possessing a card;

FIG. 22 is an isometric view illustrating a product, wherein the product comprises an RFID tag;

FIG. 23 is an isometric view illustrating a remote device, wherein the remote device comprises a display for interacting with a shopper;

FIG. 24 is a top view illustrating a merchandise layout;

FIG. 25 is a perspective view illustrating a merchandise layout as illustrated in FIG. 24;

FIG. 26 is a perspective view illustrating a merchandise layout as illustrated in FIG. 24;

FIG. 27 is a perspective view illustrating a merchandise layout as illustrated in FIG. 24;

FIG. 28 is a perspective view illustrating a merchandise layout as illustrated in FIG. 24;

FIG. 29 is a block diagram illustrating a shopper selection process; and

FIG. 30 is a block diagram illustrating a shopper selection process.

FIG. 31 is an isometric view illustrating a multiple security level display system;

FIG. 32 is a side view illustrating a multiple security level display system;

FIG. 33 is a front view illustrating a multiple security level display system;

FIG. 34 is a partial view illustrating an electronic lock of a multiple security level display system;

FIG. 35 is a cross-sectional front view illustrating a multiple security level display system, wherein a product exhibit device of the multiple security level display system is in a display position;

FIG. 36 is a cross-sectional front view illustrating a multiple security level display system, wherein a product exhibit device of the multiple security level display system is in a storage position;

FIG. 37 is an isometric view illustrating a multiple security level display system;

FIG. 38 is an isometric view illustrating a multiple security level display system;

FIG. 39 is an isometric view illustrating a multiple security level display system, wherein a product exhibit device of the multiple security level display system includes a storage compartment having a drawer;

FIG. 40 is an isometric view illustrating a product exhibit device including a storage compartment;

FIG. 41 is a top view illustrating a product exhibit device including a storage compartment;

FIG. 42 is a partial cross-sectional front view illustrating a multiple security level display system, wherein a product exhibit device of the multiple security level display system includes a storage compartment, and the product exhibit device is in a display position;

FIG. 43 is a partial view illustrating a storage area cover assembly;

FIG. 44 is a cross-sectional view illustrating a storage area cover assembly;

FIG. 45 is a partial view illustrating a storage area cover assembly;

FIG. 46 is a partial view illustrating a storage area cover assembly;

FIG. 47 is a side view illustrating a storage area cover assembly;

FIG. 48 is an isometric view illustrating a lift mechanism;

FIG. 49 is a front view illustrating a lift mechanism;

FIG. 50 is an isometric view illustrating a lift mechanism;

FIG. 51 is an isometric view illustrating a product exhibit device assembly;

FIG. 52 is an isometric view illustrating a connection of two multiple security level display systems;

FIG. 53 is an isometric view illustrating a plurality of multiple security level display systems;

FIG. 54 is a flow diagram illustrating a method for monitoring RFID tagged product by a display system;

FIG. 55 is a partial view of a store having a multiple security level display system and a remote digital identification receiver located apart from the multiple security level display system; and

FIG. 56 is a block diagram illustrating a digital identification system.

### DETAILED DESCRIPTION OF THE INVENTION

Reference will now be made in detail to the subject matter disclosed, which is illustrated in the accompanying drawings.

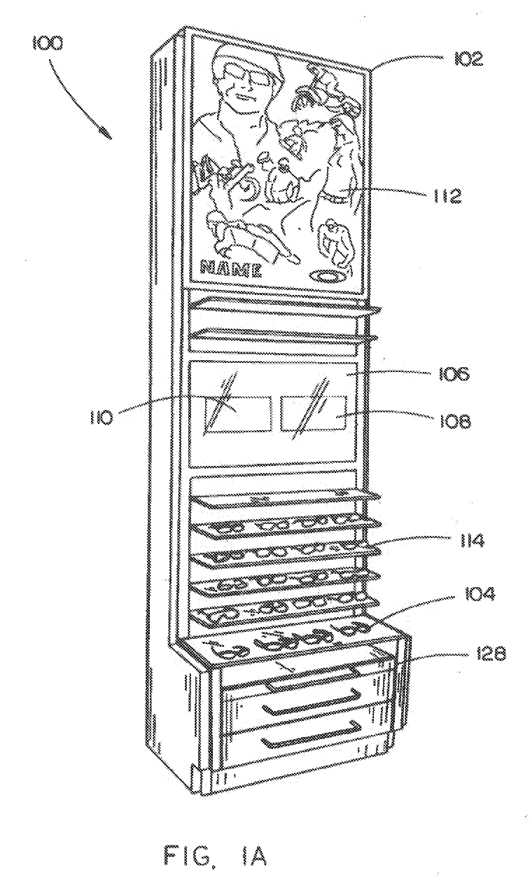

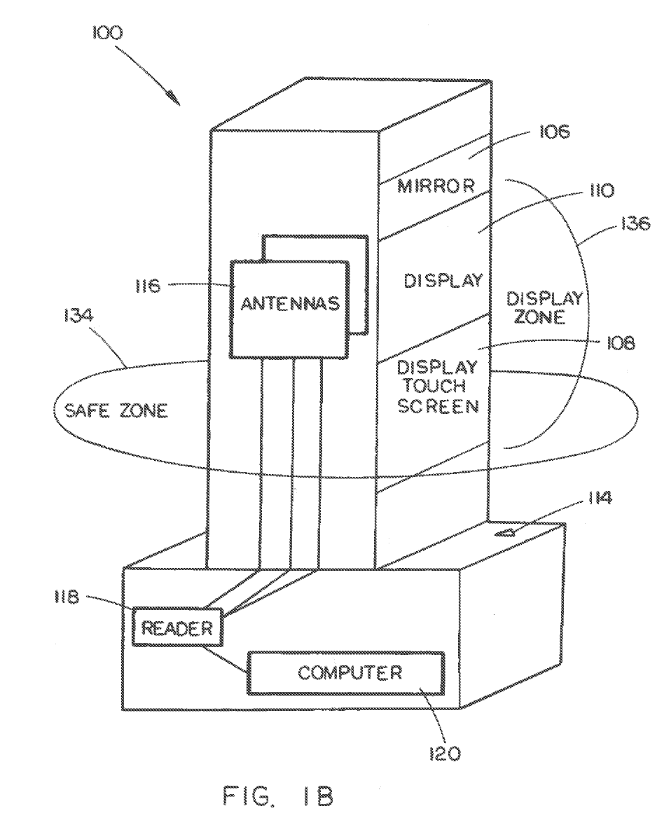

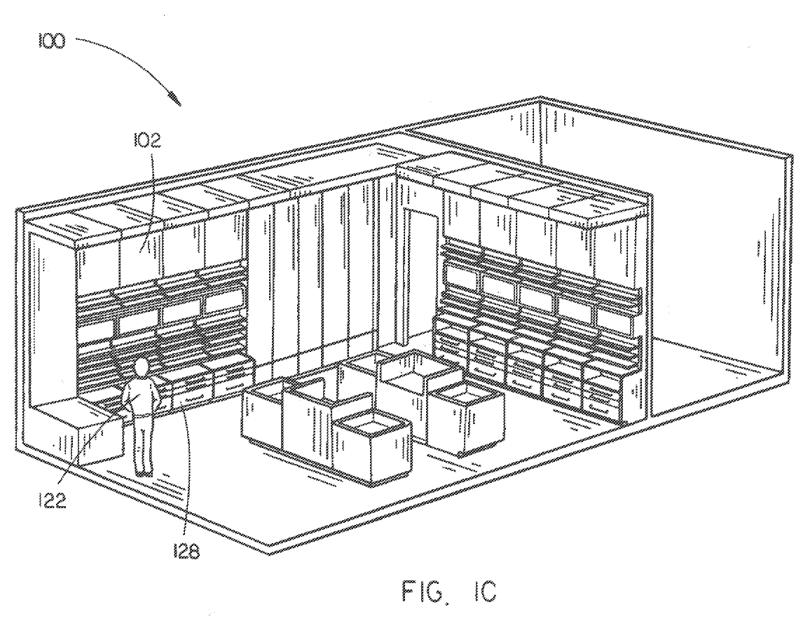

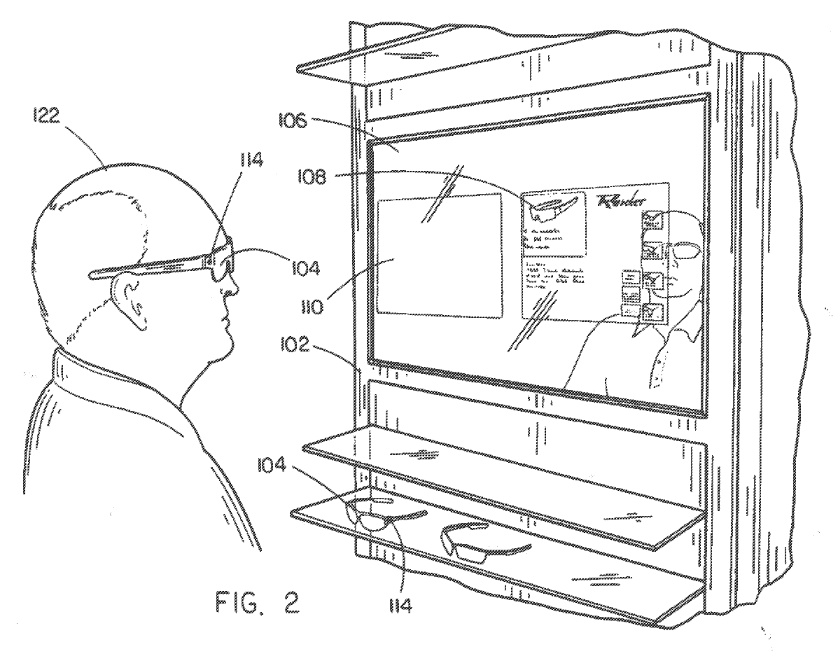

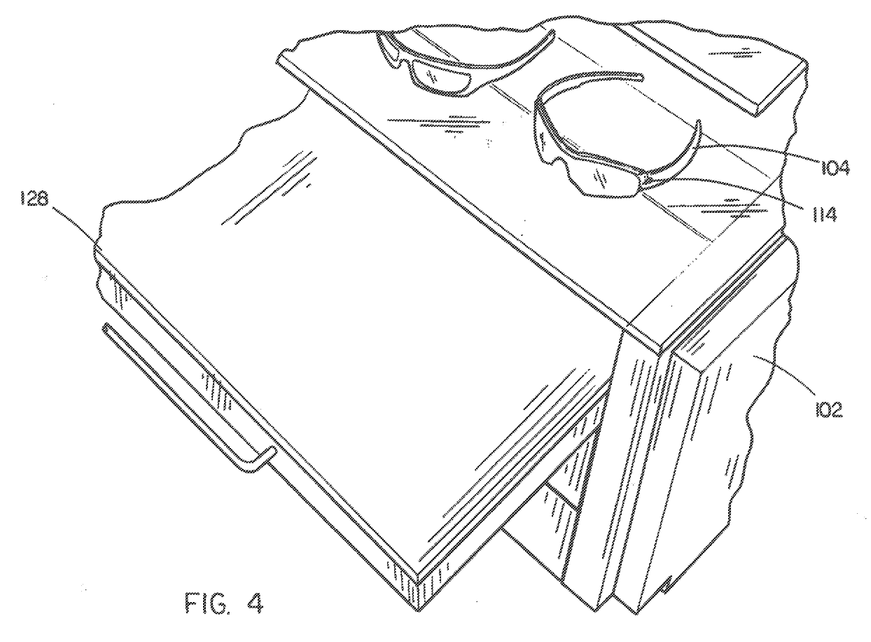

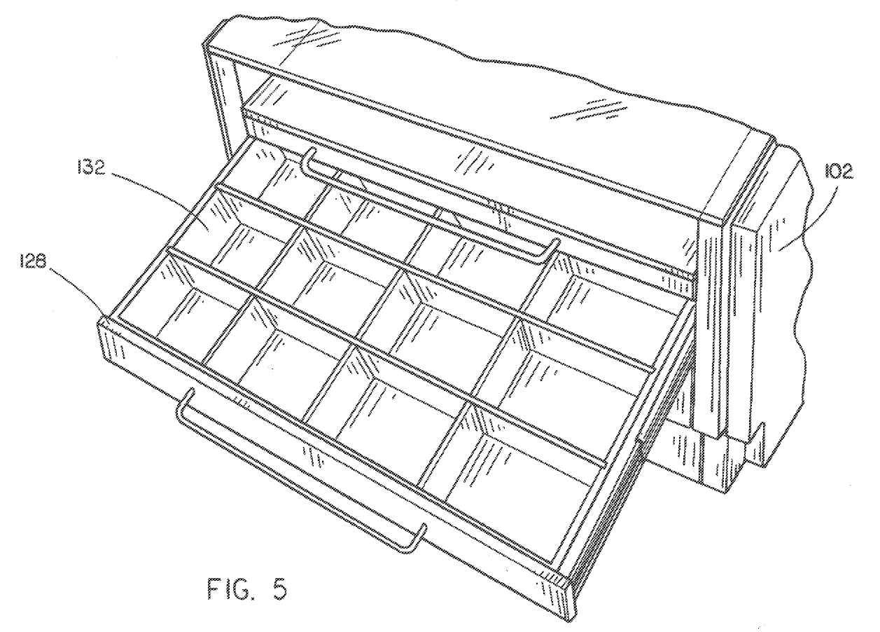

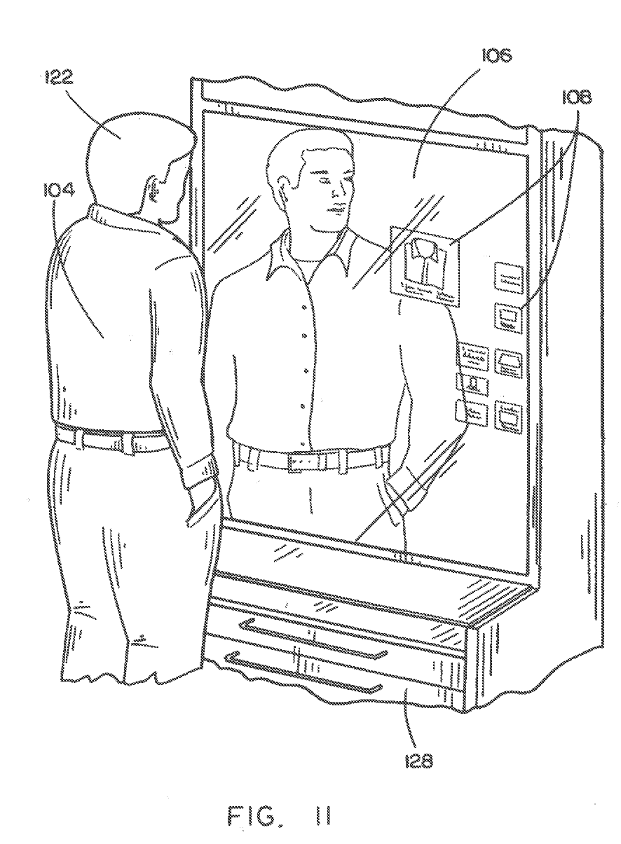

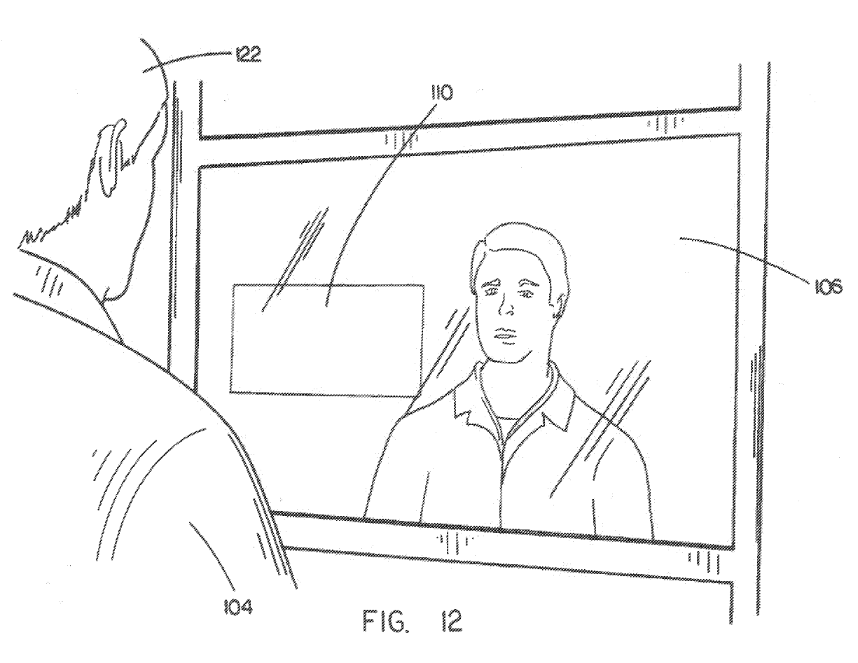

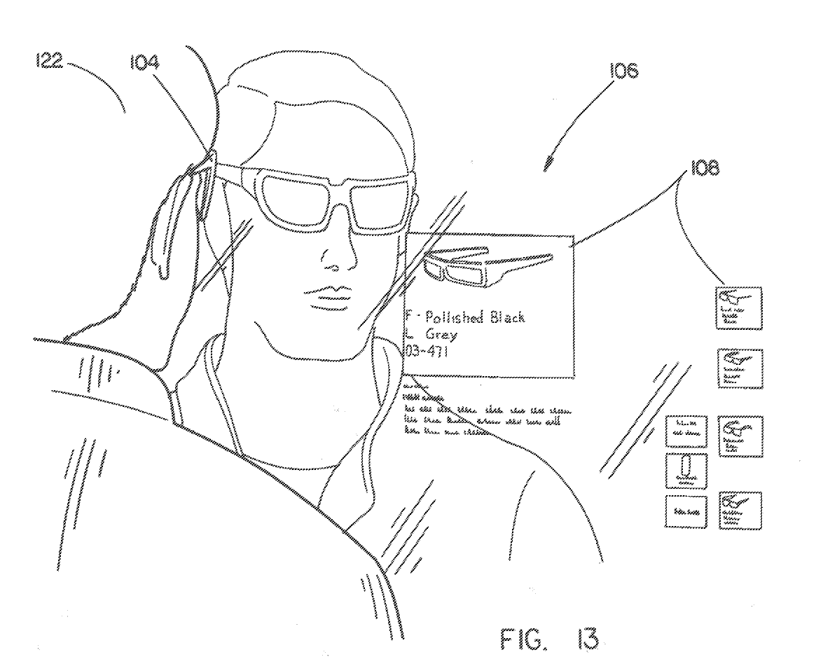

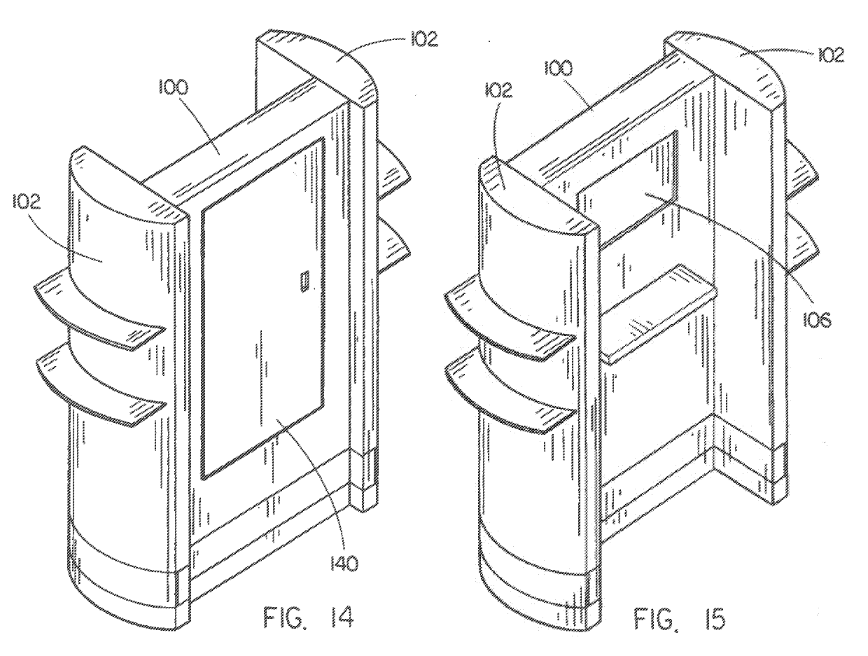

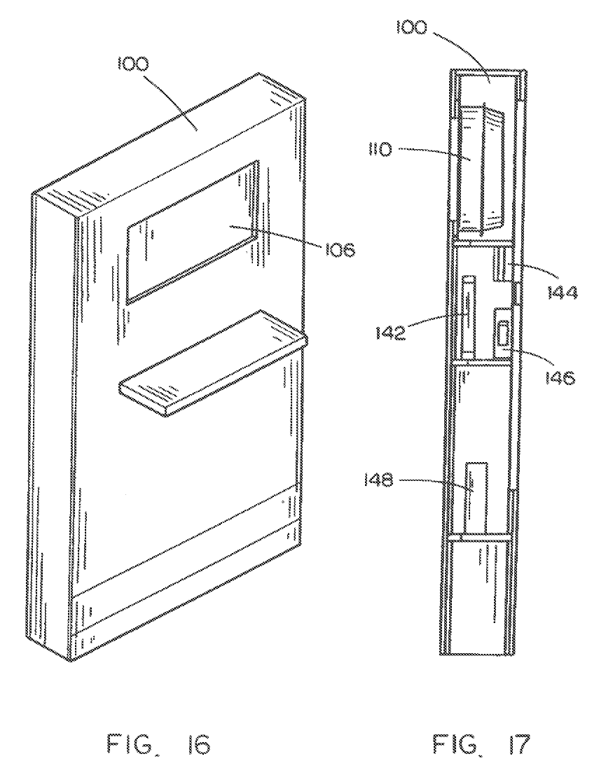

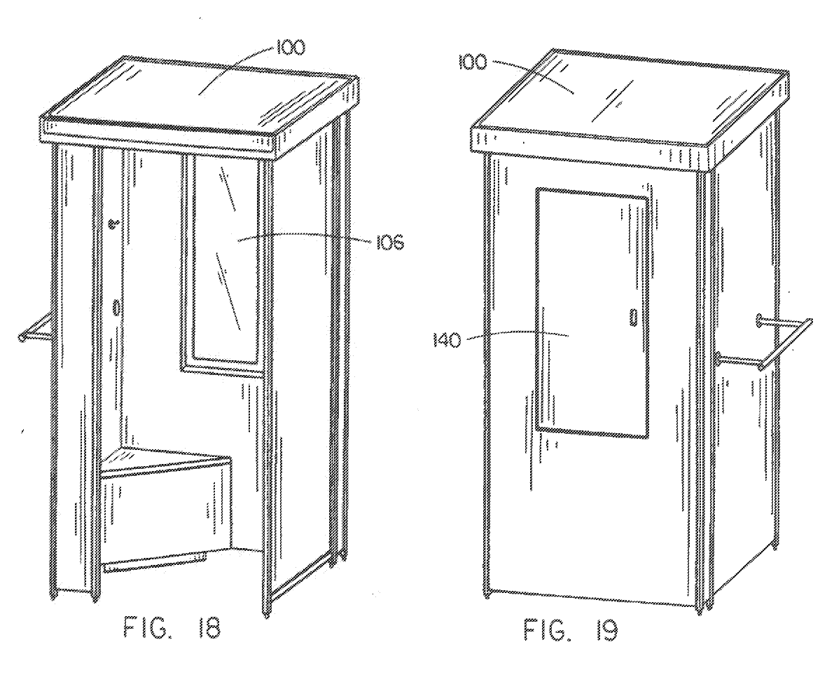

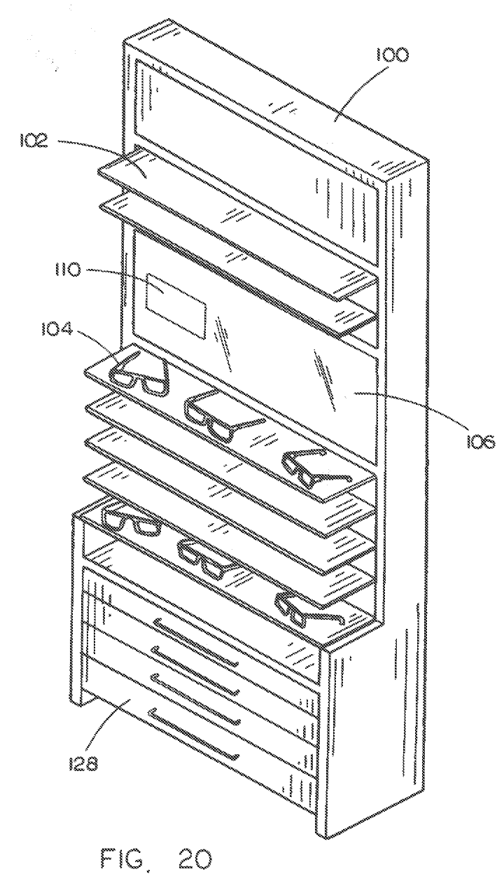

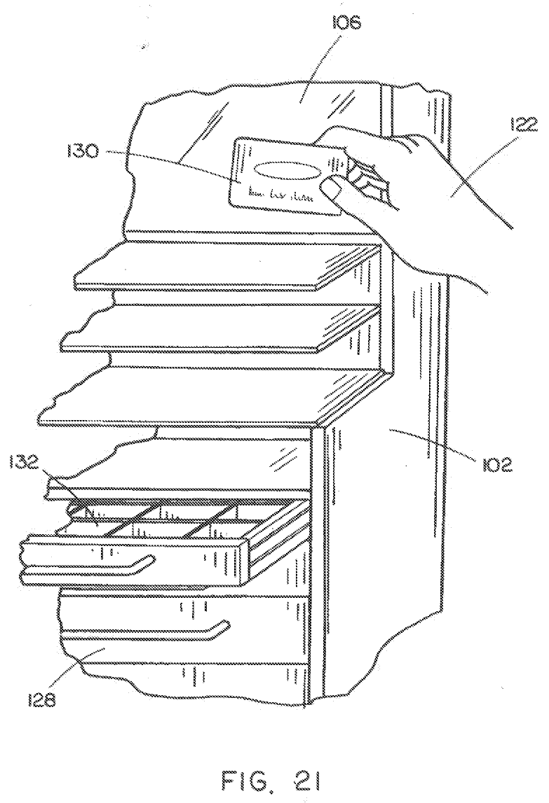

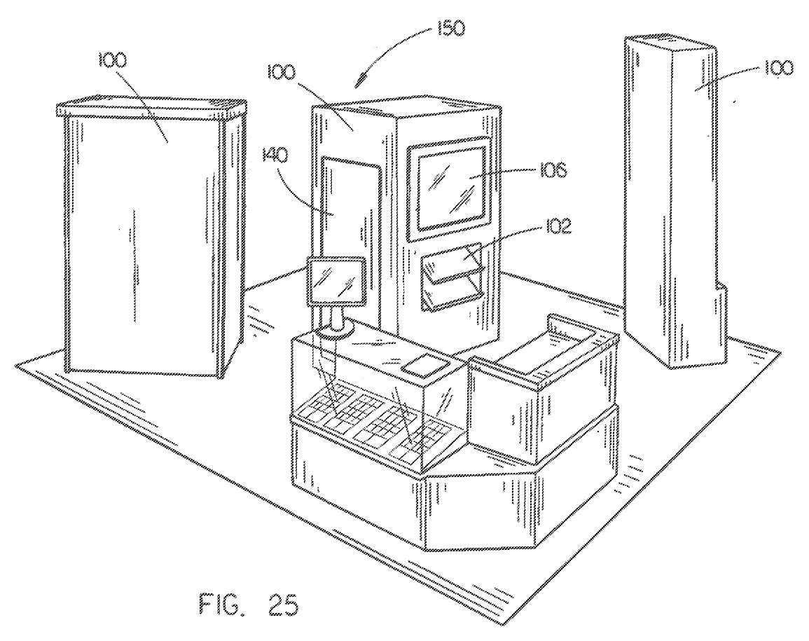

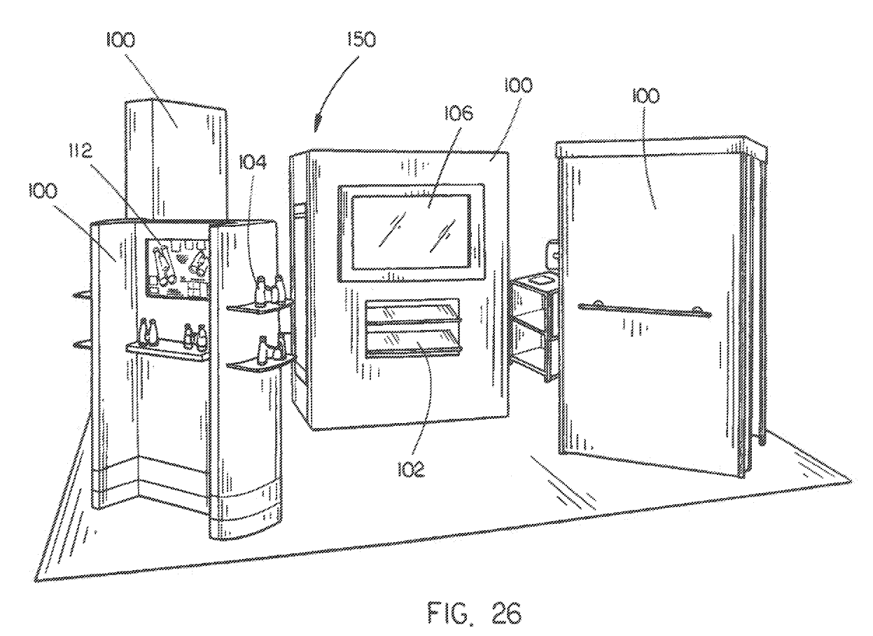

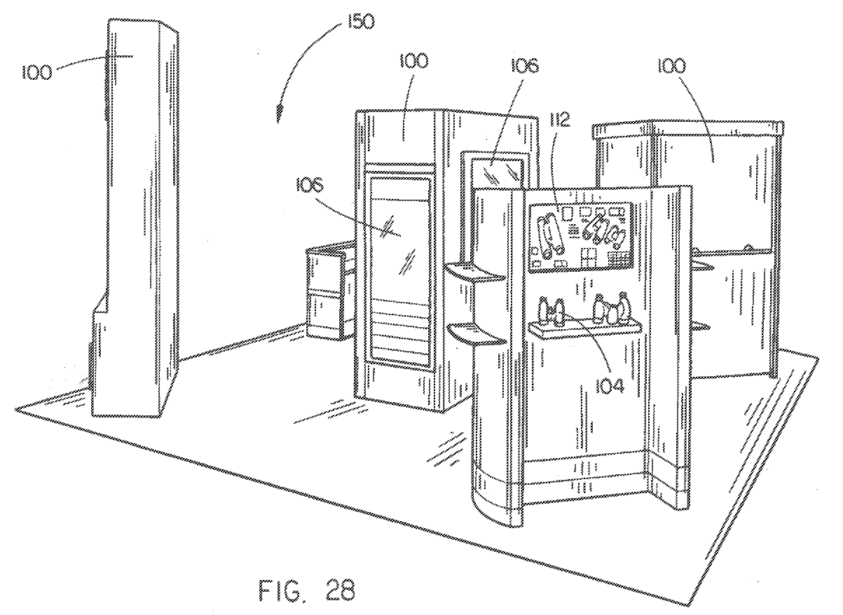

Referring generally to FIGS. 1 through 5, 11 through 22, and 24 through 28, an interactive display system 100 is described in accordance with the present invention. The system may include one or more shelving units 102, one or more RFID tagged products 104, a two-way mirror 106, a display 110, a touch screen 108, an image capture device 126, a billboard 112, one or more RFID tags 114, one or more antennas 116, an RFID reader 118, a computer 120, a picture 124, one or more drawers 128, one or more bins 132, a safe zone 134, and/or a display zone 136 (FIG. 1B). For example, in one embodiment a shelving unit 102, a drawer 128, RFID tags 114, an antenna 116, an RFID reader 118, and bins 132 are included for displaying and storing RFID tagged products 104 (as illustrated in FIGS. 1A, 1C, 4, 5, 14 through 22, and 24 through 28). In another embodiment, a shelving unit 102, a drawer 128, RFID tags 114, an antenna 116, an RFID reader 118, and a safe zone 134 are included for securing RFID tagged products 104 (as illustrated in FIGS. 1A, 1B, and 14 through 22). In still a further embodiment, a shelving unit 102, RFID tagged products 104, a two-way mirror 106, a touch screen 108, an image capture device 126, a display 110, a billboard 112, RFID tags 114, an RFID reader 118, a computer 120, a picture 124, and a display zone 136 (FIG. 1B) are included for interacting with a shopper 122 (as illustrated in FIGS. 1A, 1B, 1C, 2, 3, 11 through 22, and 24 through 28).

Referring now to FIGS. 1 through 3, 11 through 20, 22, 29, and 30, an interactive display system 100 is shown. The interactive display system 100 may collect information about a shopper's interaction with a product 104 and store the collected information in memory 146. The collected information may include: the aggregate time the shopper 122 interacted with the product 104, the number of calls for assistance, the location of the product 104 in relation to the kiosk, the number of times the product 104 was sold, and/or the amount of time the shopper 122 spent interacting with the interactive display system 100, among other things. In one embodiment, the information regarding shopper interaction may be accessed through a web portal.

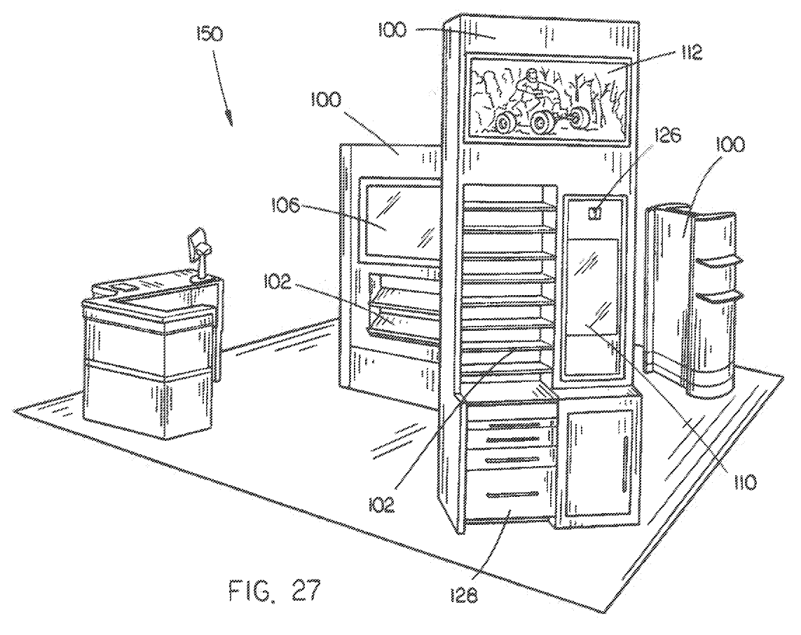

The interactive display system 100 may further include a sensor (e.g., image capture device 126, as illustrated in FIG. 27) for sensing one or more attributes of the shopper 122. The interactive display system 100 may also include a memory 146 for storing one or more associations between the attributes of the shopper 122 and the product 104. For example, the shopper 122 may approach the interactive display system 100 and touch the product 104. The interactive display system may sense shopper interaction with the product 104, collect physical attributes of the shopper 122 with the sensor, and record the collected information in memory 146. The physical attributes a sensor may detect from the shopper 122 include a shopper's body type, complexion, eye color, face shape, gender, hair color, height, skin tone and/or weight, among other things. For example, a scale may be included near a kiosk for sensing a shopper's weight. Alternatively, the image capture device 126 may be utilized to sense a shopper's height. In another embodiment, the interactive display system may sense shopper interaction and collect behavioral characteristics of the shopper 122 with the sensor and record the collected information in memory 146. The behavioral characteristics the interactive display system 100 may detect from the shopper 122 include a shopper's browsing history, gift buying history, promotional purchasing profile, purchasing profile and/or seasonal buying profile. It is appreciated that a variety of physical attributes and behavioral characteristics may be sensed by the interactive display system 100 without departing from the scope and intent of the disclosure.

The interactive display system 100 may further utilize the business intelligence collected from the shopper 122 (e.g., physical attributes and/or behavioral characteristics) to create an optimal sales atmosphere, and/or to personalize interaction with the shopper 122. In one embodiment, business intelligence may be used to determine optimal product placement, pinpoint an ideal price for the sale of a product 104, create a database of shopper preferences, generate an ideal shopper profile, determine an optimal kiosk location, tailor merchandise suggestions to a specific shopper or a type of shopper, increase the attractiveness of a display, record the ratio of male to female shoppers, track which accessories are purchased with each product, and/or create targeted advertisements, among other things.

Referring now to FIGS. 1 through 3, 6, 8, and 10 through 22, an interactive display system 100 is shown. The interactive display system 100 may include one or more shelving units for displaying a variety of products. The interactive display system 100 may also include a mirror (e.g., two-way mirror 106), a display 110, a screen (e.g., touch screen 108), an image capture device 126, a billboard 112, one or more antennas 116, one or more RFID tags 114, a receiver (e.g., an RFID reader 118), a computer 120, a picture 124, and a zone (e.g., a display zone 136; FIG. 1B), which are included for a shopper 122 to manipulate and/or view the features of one or more RFID tagged products 104. For example, the potential shopper 122 is attracted to the interactive display system 100 and as a result, desires to look at available products. The interactive display system may allow the shopper 122 to browse the product selection using a touch screen 108. The touch screen may show the shopper 122 which items were advertised on a billboard 112 and items featured in magazines, among other things. The touch screen may give the shopper 122 a number of options regarding the product, including trying on the product, getting more information about the product, requesting staff/personnel assistance, purchasing the product, and/or shipping the product. Also, the interactive display system 100 may show the shopper 122 holding or wearing the product and allow the shopper 122 to manipulate the product's distinguishable features while it is being held or worn.

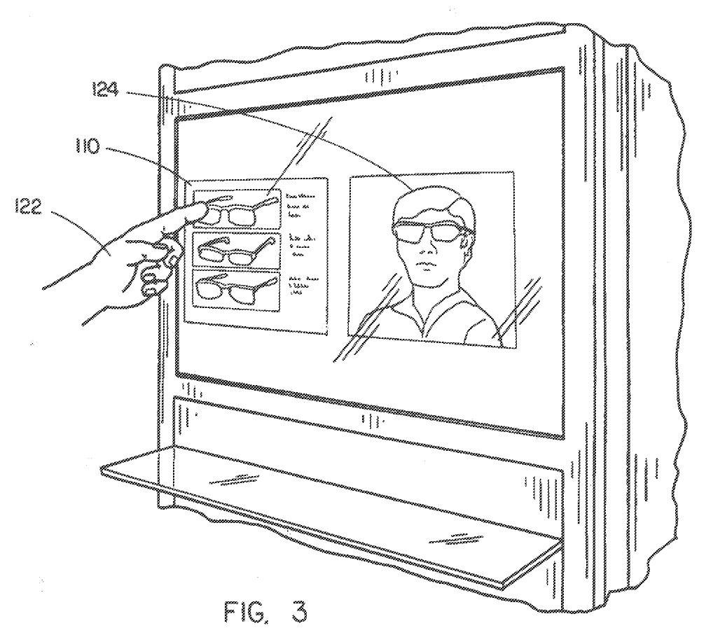

The display 110 may comprise a two-way mirror 106. The display 110 may utilize a touch screen 108. The two-way mirror 106 may be customized per location, product, and/or company. The display 110 may comprise a 3-D touch screen 108. The display 110 may comprise a 3-D touch screen 108 along with the two-way mirror 106. The 3-D touch screen 108 may be a 17-inch touch screen that may be vertically aligned with other displays 110 to appear as one large screen. The display 110 may comprise a 3-D touch screen 108 that may display the RFID tagged product 104 and allow the shopper 122 to change one or more distinguishable characteristics of the product 104, including: options, accessories, designs, decals, finishes, form factors, hues, materials, patterns, shapes, sizes, styles, textures, tints, and/or colors of an RFID tagged product 104 on the 3-D display 110, as illustrated in FIG. 3. The display 110 may allow a shopper 122 to build a 3-D picture of a product from scratch. Further, the display 110 may allow the shopper 122 to purchase the changed product created by the shopper 122 or the product designed from scratch by the shopper 122. It is appreciated that other types of displays 110 may be utilized within an interactive display system 100 without departing from the scope and intent of the disclosure.

The display 110 may utilize peripheral devices, such as speakers and an image capture device 126 for various functions, including capturing an image of the shopper 122. For instance, the interactive display system 100 may record, display, and/or print a picture 124 of a shopper 122 wearing a selected product, the RFID tagged product 104, or a shopper created product. The shopper 122 may be able to manipulate a display picture 124 of herself with the product by utilizing the touch screen 108. The shopper 122 may be able to change the color, option, and/or accessories of the product being displayed on the picture 124 of the shopper 122. The shopper 122 may be able to change the product being displayed on the picture 124 of the shopper 122 (e.g., changing the product 104 to another product which is a member of the same family of products as the product 104). The picture 124 of a shopper with the product may be sent from the shelving unit 102 to the shopper 122. The picture 124 and/or information regarding the product 104 (or another product) may be sent to an email address, personal data assistant, cell phone, and/or any other electronic media device.

Referring now to FIGS. 1A, 2, 6 through 9, and 11 through 22, one or more RFID tagged products 104 for offering for sale to a shopper 122 are shown. An RFID tagged product 104 may include one or more RFID tags 114 for transmitting an RFID signal (e.g., a product identification signal) to an RFID reader 118. The RFID reader 118 may be included with the interactive display system 100 for receiving product information and/or for determining the location of the product 104. For example, a shopper 122 may approach an interactive display system 100 looking for a particular product. The shopper 122 may pick up the product in order to view the product in the mirror 106, signaling the interactive display system 100 to provide the shopper 122 with product information. The interactive display system 100 may tell the shopper the price of the product, its features, suggest complementary accessories, and/or whether it is in stock, among other things.

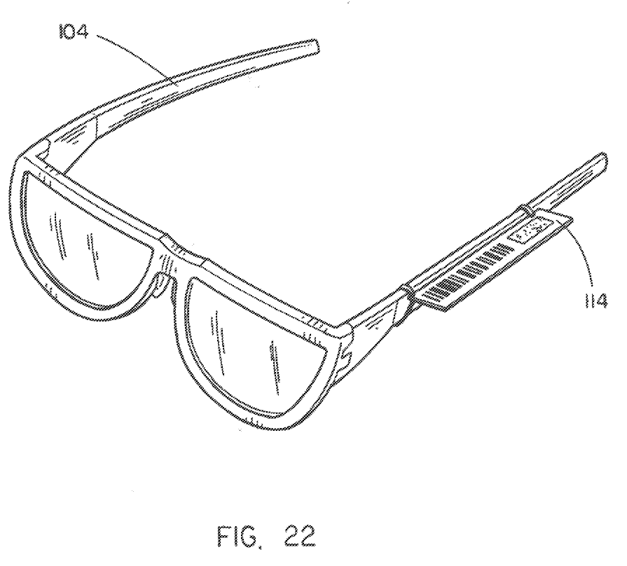

Referring now to FIGS. 1A, 2, and 14 through 22 a product 104 is illustrated with an attached RFID tag 114. While the product 104 is shown in FIG. 22 to be sunglasses, it is appreciated that other products may be used, such as, belts, eyeglass and sunglass frames, watches, jewelry, handbags, winter apparel, perfume, personal data assistants, cellular phones, cameras and other products as desired. An RFID tag 114 may be fixedly attached to a product 104 by means of a strap, zip tie, adhesive, screws, snaps, and/or staples. The RFID tag 114 may also be contained within a product 104 and/or manufactured as part of a product 104. It is contemplated that there are a variety of ways to attach an RFID tag 114 to a product 104 without departing from the scope and intent of the present invention. It is further anticipated that an RFID tag 114 may be attached to a product 104 in a way that the RFID tag 114 is not substantially visible when worn by the shopper 122 so as not to obstruct the shopper's view of themselves in the interactive display system 100.

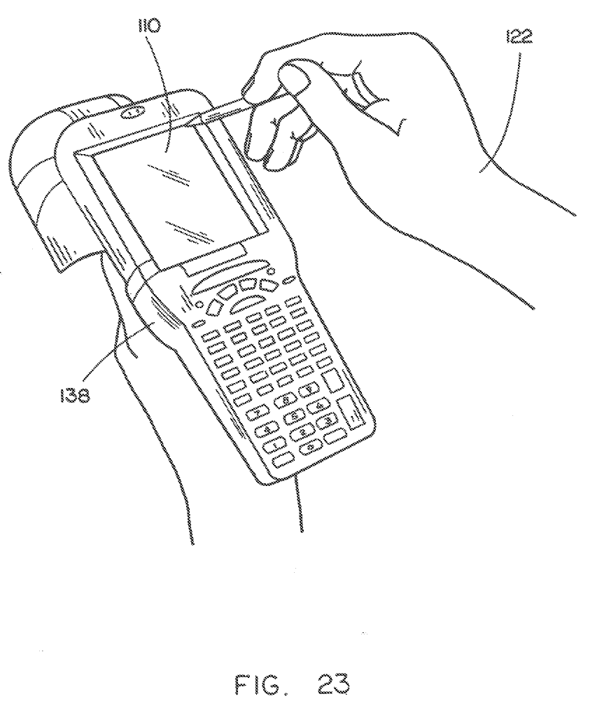

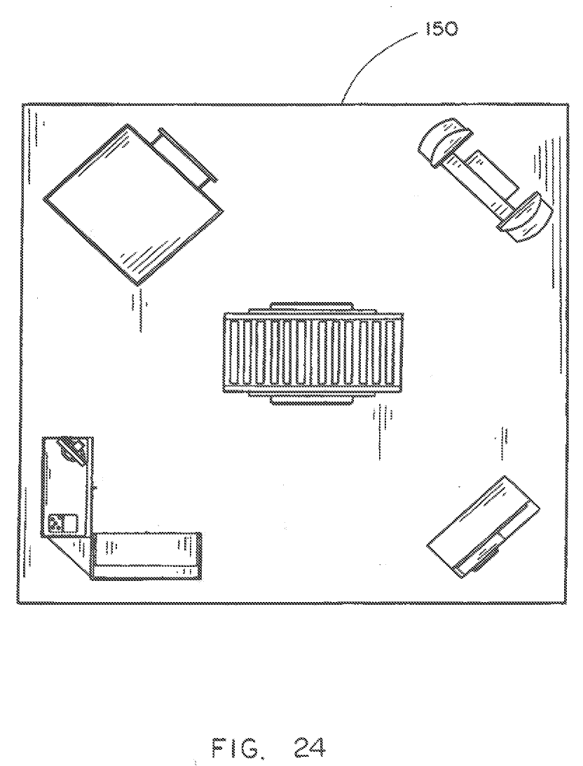

The RFID tags 114 may be customized and may be directly attached to the product 104. The RFID tags 114 may be attached by the manufacturer and/or the retailer. The RFID tags 114 may be entered into the interactive display system 100 by the manufacturer and/or the retailer. Boxes containing the products may also be RFID tagged and entered into the interactive display system 100 by the manufacturer and/or the retailer. A portable and/or hand held device (e.g., a personal data assistant/remote device 138, as illustrated in FIG. 23) may be utilized to scan RFID tags 114 and/or enter the RFID tagged products 104 into the interactive display system 100.

In some embodiments, the RFID tagged product 104 may transmit a product identification signal indicative of a product type. For example, one specific product type may include a family of products (e.g., a group of products having like form factors). Alternatively, the product identification signal may be indicative of a single product (e.g., a product having a specific part number). Further, the product identification signal may be indicative of a characteristic of the product. For instance, the product identification signal may be indicative of a color, a decal, a design, a finish, a form factor, a hue, a material, a pattern, a shape, a size, a style, a texture, and/or a tint. In one specific embodiment, the product identification signal may indicate a color for the product 104.

Referring now to FIGS. 1A, 1B, 2, 3, 6, 8 and 10 through 23, an apparatus for capturing and manipulating an image of a user is shown. The apparatus comprises a display 110, antennas 116, one or more RFID tags 114, an RFID reader 118, and a computer 120 which are included to capture, display and/or store the image. For example, a shopper 122 may approach an interactive display system 100 interested in purchasing one or more RFID tagged products 104. The shopper 122 may interact with one or more products (e.g., wearing the product 104 and viewing the product in the mirror 106), signaling the interactive display system 100 to provide the shopper 122 with product information. The interactive display system 100 may show the shopper 122 holding or wearing the product. The interactive display system 100 may further allow the shopper 122 to view one or more distinguishable attributes of the product while the product is being held or worn. This feature may allow the shopper 122 to peruse the product's distinguishable attributes without having to pick up other items.

The display 110 may comprise one or more displays. The display 110 may be a 17-inch LCD monitor that is vertically aligned with other displays 110 to appear as one large screen. The display 110 may display details, specifications, and/or other desired information about selected products or about an RFID tagged product 104 displayed on the shelving unit when the RFID tagged product 104 is moved. The details, specification, and/or information may be located generally on one side of the display 110. The display 110 may comprise a display zone (FIG. 1B) 136 that reacts to RFID tags 114 when moved into a operator definable display zone 136. The display 110 may comprise a menu that may be navigated by the shopper 122 to see different options, specifications, products, prices, sales, and/or any other shopper desired information. The specifications, information, and options may comprise material such as product name, starting price, color options, descriptions, and/or styles. The display menu may have a specialized menu for a retailer that allows the retailer and/or sales associates to access reports specific to a shelving unit 102, store location, and/or an interactive display system 100.

The display menu may comprise numerous options. The display menu may comprise a help option. The help option may allow a shopper 122 to speak with a sales associate, provide in store location details, additional product information, accessory information, accessory location information, and/or any other desired information. The interactive display system 100 may further comprise a GPS system that allows a retailer to track the locations of various shelving units 102 and/or products and/or allows a shopper 122 to get directions to other store locations. The GPS function may also be a menu option.

The display 110 and/or the menu on the display 110 may comprise a buy now option/icon or a buy on-line option/icon. When activated, the buy now option/icon may send an alert to a sales associate's handheld information handling system device (e.g., a personal data assistant/remote device 138, as illustrated in FIG. 23) that a shopper 122 is ready to purchase a product. Additionally, when activated, the buy now option/icon may automatically ring up the product. The buy now option/icon may allow the shopper 122 to purchase the desired product at the shelving unit 102 without the help of a sales associate. The buy on-line option may allow a shopper 122 to purchase the product on-line and allow the shopper 122 to ship a purchased product to a desired location. Further, the interactive display system 100 may include a transmitter (e.g., an antenna 116) for transmitting information to the remote device 138, including information regarding a request for assistance, a location of a product 104, and/or an alert regarding a product 104. The remote device 138 may be configured to receive the transmitted information and/or store the information and/or alert a sales associate accordingly.

The graphics on the screen 108 may be designed and/or customized per company, per location, and/or per product. The graphics may display a watermark with a company logo and/or trademark. The display 110 may display an enlarged picture of the RFID tagged product 104 and/or a picture of a celebrity wearing the RFID tagged product 104. The display 110 may display a video clip on a portion of the display 110 or on the entire display 110. The display 110 may display a plurality of video clips on a portion of the display 110 or on the entire display 110.

In some embodiments, the interactive display system 100 may include an emulation module comprising a remote system (e.g., a web interface) for allowing the shopper 122 and/or the retailer to access a portion of the store services on-line. The emulation module may allow a shopper 122 to build a 3-D picture of a product from scratch on-line. The emulation module may allow a retailer to check the status of her inventory and/or the amount of sales for a period of time on-line. The emulation module essentially emulates as many functions as possible that may be performed by a shelving unit 102 and provides access to these functions on-line.

The interactive display system 100 may further include a card module comprising a plastic card 130 (e.g., a card similar in shape and appearance to a credit card) with an RFID tag 114 and/or some type of memory storage capacity. The card module may be utilized by a shopper 122 and/or a retailer. The shopper 122 may utilize the card to track products moved, products selected, information regarding products of interest, the date the shopper 122 tried on a product, the date a shopper 122 moved a product, a picture 124 of the shopper 122 in the product, and/or any other information the shopper 122 may desire. The card module may further store information about the shopper 122, such as name, address, and/or telephone number. Moreover, the card may be utilized as the store credit card.

The card module 130 may be utilized as a reward system for a shopper 122. For example, the card module 130 may record the number of products purchased by a shopper 122, the amount of money spent by a shopper 122, and/or the number of stores visited by a shopper 122 to provide coupons and/or saving to loyal shoppers. The savings may even be designed and/or individualized for each shopper 122 by providing discounts for accessories associated with known purchased products.

The interactive display system 100 may perform additional communication functions. The interactive display system 100 may verbally communicate with a shopper 122. The verbal communication may be adjusted to accommodate different languages as desired. The interactive display system 100 may be instructed to change from one language to another via shopper 122 selection. The interactive display system 100 may also comprise voice recognition software. The interactive display system 100 may further comprise a voice activated interface. The shelving units 102 may respond verbally and/or by writing on the display 110. Additionally, the shelving unit 102 may change languages based on the language spoken to the shelving unit 102.

The interactive display system 100 may utilize peripherals, such as speakers, printers, and/or cameras to implement desired functions. The interactive display system 100 may generate customized or related sounds based on shopper selections and product movement by utilizing a tuner, a radio, an antenna, and/or a speaker. The interactive display system may further utilize peripheral devices for announcements and/or sales associate communication. A speaker and/or a microphone may be utilized to allow a shopper 122 to talk directly with a sales associate from a shelving unit 102. The shelving unit 102 in conjunction with the peripheral devices may be further utilized to communicate the status of a shopper order and/or service, such as the checkout of a product or the finishing of a cleaning and/or maintenance service.

It is contemplated that the interactive display system 100 need not include the products 104, RFID tags 114, antennas 116, and/or RFID readers 118. For example, the interactive display system 100 may be utilized for advanced window shopping. In this embodiment, an interactive display system 100 may be primarily comprised of a display 110. The display 110 may further comprise a touch screen 108, a keyboard, and/or a mouse. The display 110 may show products. The display 110 may be capable of being utilized by a shopper 122 standing outside of a store through a glass window. The display 110 may allow a shopper 122 to select different products, change the colors and/or features of different products, build products from scratch, and/or accessorize a product. The display 110 may further allow a shopper 122 to purchase the designed product. The shopper 122 may pick up the designed product inside the store or may have the designed product shipped to a desired address. The shopper 122 may be able to pay for the designed product at the shelving unit or inside the store.

The interactive display system 100 may comprise different types of shelving units 102. The term “shelving unit” as used herein refers to stationary shelves, rolling shelves, portable shelves, portable carts, rolling carts, stationary racks, portable racks, rolling racks, stationary vaults, portable vaults, rolling vaults, stationary display cases, rolling display cases, portable display cases, warehouse shelves, stationary lockers, rolling lockers, portable lockers and/or any other suitable structure for storing and/or displaying a product. The shelving unit 102 may have numerous configurations. The shelving unit 102 may comprise shelves, drawers 128, billboards 112, bins 132, cubbies, racks, hooks, slots, and/or any other suitable display apparatus.

Referring now to FIGS. 1 through 6, 11 through 22, and 24 through 28, an interactive display system 100 is shown. The interactive display system 100 comprises one or more shelving units 102. Referring to FIG. 1C, a plurality of shelving units 102 in an interactive display system 100 is shown. It is contemplated that there are a variety of ways to assemble the interactive display system 100. The parts of an interactive display system 100 may be rearranged so that retailers may have a variety of product display options. Additionally, it is anticipated that the parts of an interactive display system 100 may be removed so that parts can be easily fixed, replaced and/or reinstalled. In some embodiments, parts of the interactive display system 100 may be accessed through an access panel 140 for removal, repair and/or rearrangement.

Referring now to FIGS. 1A, 1C, 4 through 5, 14 through 22, and 24 through 28, a second product substantially similar to the product 104 may be contained in a compartment (e.g., locking drawer 128) of an interactive display system 100. The locking drawer 128 may be utilized for storing a second product for purchase by the shopper 122. Thus, the product 104 may be utilized for display while the second product may be restocked when purchased. The second product may be identical to or substantially similar to product 104 (e.g., of the same model number/product family). Because the second product is secured by the locking drawer 128, an RFID tag 114 need not be attached to the second product. The locking drawer 128 may be unlocked by a sales associate using a handheld device 138, a remote signal, key, security card, password and/or other authorization device. For example, in one embodiment, a card (e.g., card 130) may include an RFID transmitter for transmitting a signal to unlock the locking drawer 128. It is contemplated that the drawer 128 may be composed of one or more bins 132 for storing one or more products. It is further anticipated that the interactive display system 100 may be prompted to unlock a drawer 128 if a shopper 122 uses her credit card to make a purchase. Alternatively, the drawer 128 may function as a vending slot, releasing a product when prompted by the interactive display system 100. It is appreciated that a drawer 128 may be utilized for any other suitable purpose within an interactive display system 100 without departing from the scope and intent of the disclosure.

Referring to FIGS. 1 through 6, 11 through 22, and 24 through 28, an interactive display system 100 is shown. The interactive display system 100 comprises a shelving unit 102 or a plurality of shelving units 102. Referring to FIG. 1C, a plurality of shelving units 102 in an interactive display system 100 is shown. The interactive display system 100 may comprise middleware systems to perform multiple functions that are beneficial to a shopper 122, a manufacturer, and/or a retailer.

Each shelving unit 102 may comprise autonomous middleware systems that may communicate with other middleware systems, other shelving units 102, peripheral devices, and/or a server. Peripheral devices may comprise speakers, microphones, bar code readers, lights, cameras, printers, keyboard, mouse, and/or any other portable or autonomous electronic devices. The interactive display system 100, the middleware systems, and/or the shelving units 102 may also utilize a microprocessor, multiplexer, and/or a computer 120 to perform desired functions. The interactive display may comprise a memory suitable for storing any information generated by the shelving units 102, middleware systems, peripheral devices, and/or any data generated by the interactive display system 100.

The interactive display system 100 may comprise RFID tags 114 and at least one of an RFID reader 118 and an antenna 116. The middleware systems may utilize the RFID tags 114 or may utilize information received from the monitoring of the RFID tags 114. Each product displayed in the interactive display system 100 may be tagged with an RFID tag 114. The RFID tags 114 may be monitored by the reader 118 and the antenna 116. The antenna 116 may send information regarding the RFID tagged products 104 located within a certain area of a particular antenna 116 to the reader 118. The reader 118 may be coupled to a database of an application host, possibly through a hub. Alternatively, the reader 118 may be coupled to the application host via a hard-wire or wireless connection. The application host may be further coupled to one or more servers through a local area connection or world wide network, such as the Internet.

The readers 118 and the antennas 116 may be Feig ultra high frequency (UHF) readers 118 and antennas 116. The Feig antennas 116 may be 10×10×2½ inches and may be in a cube configuration. The antenna 116 and the reader 118 may be built into the shelving unit 102 or into a wall utilizing a zoning theory. A basic reader 118 may be utilized for reading the RFID tags 114 and collecting data. The reader 118 may be 14×7¼×4½ inches including the cable glands and cables. A multiplexer may be operatively coupled to each antenna 116. The multiplexer may scan the field of antennas 116 in a preset order, and may prevent interference amongst antennas 116. Additionally, an antenna 116 may be a dynamic antenna 116 that may be remotely tuned across a network, such as the Internet.

The interactive display system 100 may be self-powered and/or may utilize an outside power source. The interactive display system 100 may comprise a power supply that is 7×2¼×1¼ inches including the cords. The power supply may be utilized solely by the RFID reader 118. A power strip may be 11½×2×1¼ inches. A single power strip may be sufficient to power all of the shelving units 102 in an interactive display system 100 utilized in one store. The shelving units 102 may utilize a battery and/or a rechargeable battery as a power source. The shelving unit 102 may also utilize multiple power sources as desired.

The shelving unit 102 may further comprise a sleep system and/or hibernation system. The sleep system and/or the hibernation system may conserve power by deactivating and/or activating the shelving unit upon selection, upon command, upon shopper interaction, and/or upon programming. The shelving unit 102 may enter a sleep or hibernation when the shelving unit has not been utilized for a certain amount of time. The shelving unit 102 may further comprise a motion detector. The motion detector may be utilized to activate the shelving unit 102 from a power saving hibernation or sleep. This list is not restrictive. It is appreciated that the motion detector may be utilized for any other suitable purpose within the interactive display system 100 without departing from the scope and intent of the disclosure.

The interactive display system 100 may utilize encapsulated RFID tags. The orientation of the RFID tag 114 in relation to the antenna 116 may provide improved read range, reliability, and/or accuracy of RFID tag reads. The RFID tag 114 may be an encapsulated tag shaped as a pyramid. A hanging RFID tag shaped in a pyramid, with the RFID tag on the bottom of a product, may put the RFID tag 114 and the antenna 116 parallel with one another and may increase read range, reliability, and/or accuracy of the RFID tag reads. The RFID tag 114 may also be deactivated if tampered, cut, and/or removed from the product the RFID tag 114 is tracking. The deactivation of the RFID tag 114 may be noticed and/or recorded by the interactive display system 100 for security purposes.

The interactive display system 100 allows a shopper 122 to pick up, try on, and/or feel a product. This is particularly useful for expensive products that are normally kept under lock and key because of their value. The interactive display system 100 allows products to be safely monitored by the retailer while giving shoppers access to the products. In addition, if the shopper removes the RFID tagged product 104 from the safe zone 134, the interactive display system 100 will be alerted and set in motion the theft prevention system of the retailer's choosing.

The alert module may comprise alerts that are generated when a certain function occurs, such as when an RFID tagged product 104 is taken out of an acceptable proximity or safe zone 134 of a shelving unit 102. The alert may comprise of an alarm, a siren, an email, a text message, a light, an automatic locking mechanism, a beeper, and/or notice to another security system. The alert may be sent to a specific person, such as a sales associate, and/or a certain system. The alert may be implemented in any desired area for security and/or other purposes, such as the display floor, the back room, the warehouse, and/or the storage space. The alert may be integrated with another security system.

Therefore, if a shopper 122 picks up an RFID tagged product 104 from the shelving unit 102 and walks a certain distance away (such as 5 feet) from the shelving unit 102, an alert may be generated. The alert may be activated by environmental factors, such as changes in temperature and/or changes in humidity. Further, an alert may be generated by an alert module if large numbers of products are moved within a certain time frame of each other to prevent theft. The alert module may also be activated by the tampering with and/or the removal of an RFID tag 114 from a product 104. Similar alerts may be applied to the products stored in the back room, the warehouse, and/or the storage space.

The alert module may further comprise a resolving mechanism that stops the alert when another function is performed, such as when a sales associate enters a code into the interactive display system 100 and/or shelving unit 102, a product is returned to the acceptable proximity (or safe zone 134), and/or a security card is scanned by the interactive display system 100 and/or shelving unit 102. Manual alerts and notifications may also be generated and entered into the alert module. A sales associate may have to manually turn on and/or off an alert. It is understood that a number of customized functions may be designed for the alert module without departing from the scope and intent of the disclosure.

The alert module may utilize peripheral devices, such as a camera, automatic locks, a motion detector, an infrared detector, and the like for added security. The alert module may even comprise an algorithm for locating and/or recording specific behaviors that may be considered suspicious. This list is not restrictive. It is appreciated that other suitable peripheral devices and/or security systems may be utilized with the present invention without departing from the scope and intent of the disclosure.

The network monitoring module may comprise the ability to monitor all of the readers 118, the antennas 116, and zones of an interactive display system 100, of a plurality of shelving units 102, and/or of an entire store. Further, the network monitoring module may allow a retailer to view all of the readers 118, the antennas 116, the zones, and the shelving units 102 of an interactive display system 100, of a plurality of shelving units, and/or of an entire store and/or a plurality of stores at a glance.

The back room module may comprise a separate portal from the display 110 to monitor, receive, and/or track RFID tagged products 104 in a back room and/or a storage area. The inventory may be monitored and/or tracked for generation of complete inventory details per store, location, and/or region.

The authentication module may comprise alerts and/or notifications. The authentication module may confirm that a product is authentic and/or was purchased at the retailer's store. The authentication module may prevent the returning of fraudulent products and/or the return of products purchased at a different retailer.

The card 130 may additionally be utilized to provide security access for sales associates. The card 130 may activate and/or disable alerts, locks, shelving units 102, and/or doors when a card is located near a certain reader 118, antenna 116, and/or access panel 140. For instance, a card 130 may unlock a drawer 128 in a shelving unit 102 when the card is within a certain range of the shelving unit 102.

The interactive display system 100 may be integrated with middleware systems, point of sale systems, and/or inventory systems as needed. Various middleware systems may be utilized in the interactive display system 100. The middleware systems may comprise an alert module, a display 110, an inventory module, a report module, a zoning module, a network monitoring module, a back room module, an emulation module, a card module, and/or an authentication module. One or more of the modules may be enterprise accessible and/or implemented at the corporate level.

Enterprise accessibility may provide for access to information generated by the shelving unit 102 in any and/or all of the store locations. Furthermore, the execution of the middleware systems may be written in the c#.net programming language.

Referring now to FIGS. 1A, 1B, 2, 3, 6, 8, and 11 through 22, a system for ascertaining shopper preferences for high cost items is shown. The system may comprise one or more shelving units 102. The interactive display system 100 may be further comprised of a two-way mirror 106, a display 110, a touch screen 108, a billboard 112, one or more antennas 116, one or more RFID tags 114, an RFID reader 118, and/or a computer 120 which are included for collecting and/or storing data collected from an interactive display system 100. For example, the system may track its interaction with shoppers and use the collected information to formulate data regarding the popularity of a product 104, the amount of inventory currently in stock and/or peak selling times, among other things. For example, the system may record how often a shopper 122 picks up a specific item and/or create a graph showing if there is a correlation between the data collected and actual sales. The system may further keep track of item inventory, automatically reordering a product once a certain number have been purchased. Also, the system may record how many shoppers 122 have used the interactive display system 100 over a certain period of time.

The interactive display system 100 may also be capable of sales associate notification. Each shelving unit 102 may comprise a button and/or menu selection that contacts a sales associate immediately upon selection. The interactive display system 100 may further utilize an algorithm designed to anticipate and/or determine when a shopper 122 needs sales associate assistance based on a set of physical features and/or parameters. The parameters may include facial structure software, recognition software, interactions with the display 110, shopper movement, and/or the type of shopper movement.

The display 110 may display marketing information and/or advertisements based on shopper selections and/or the moving of an RFID tagged product 104. The display 110 may display associated accessories based on shopper selections and/or the moving of an RFID tagged product 104. The display 110 may further utilize multi-media sources for the generation and/or sending of information, such as the Internet, Wi-Fi, blue tooth, and/or any other suitable electronic media. Information, products, and/or prices may be sent to a cell phone and/or emailed to a web address as desired by the shopper 122 and/or retailer. The display 110 may also generate information, graphics and/or menu options for related products to the product of interest. The display 110 may further identify the location of the related product and/or the associated accessory in the store once selected.

The inventory module tracks inventory by tracking the RFID tagged product 104. The inventory module may track inventory in real time. Additionally, descriptive information about each RFID tagged product 104 may be generated, stored, and/or analyzed by the inventory module. The inventory module may track if an RFID tagged product 104 is misplaced, purchased, moved, picked up, picked up and not purchased, out of stock, low on stock, overstocked, selected, and/or inquired about. The inventory module may even track if an RFID tagged product 104 is purchased more in a specific location on a shelving unit 102 than when displayed in other locations. The inventory module may be further utilized to locate inventory, recall defective inventory, and/or provide instant price changes. This list is not restrictive. It is understood that the inventory module may track any desired information based on the movement of the RFID tags 114 and the information recorded in any of the modules. The inventory module may further comprise the storage of a picture in association with each RFID tagged product 104. The inventory module may also comprise the storage of multiple pictures in association with each RFID tagged product 104. The inventory module may be integrated into a retailer's current inventory system.

The inventory module may monitor the quantities of products and/or may automatically order new products when a certain number is reached. The inventory module may notify the retailer by an alert that a certain product is low in stock, needs to be restocked, and/or is out of stock when a certain number is reached. The inventory module may monitor the quantities of products, automatically cancel orders and/or send orders when a certain number is reached. The inventory module may notify the retailer by an alert that a certain product is overstocked when a certain number is reached.

The inventory module may be integrated into a retailer's current point of sale system. The inventory module may be integrated into a shopper database utilized by the retailer. Further, the inventory module may be integrated with a vendor's, manufacturer's and/or supplier's databases.

The reports module may comprise a program and/or system that allows a retailer to view a pre-defined and/or customized report. The reports module may allow the retailer to view a plurality of pre-defined and/or customized reports. The reports module may generate and/or organize information generated from any of the other modules. The report module may utilize correlation software to generate reports. The reports module may generate reports based on the number of sales; how often an RFID tagged product 104 is selected, moved, and/or purchased; and/or the number of alerts generated per shelving unit, per interactive display system, per store, per locality, and/or per region. The reports module may generate reports comparing the information generated from one RFID tagged product 104 to another RFID tagged product 104. This list is not restrictive. It is understood that any desired report may be generated by utilizing any of the information recorded and/or generated by the interactive display system 100 without departing from the scope and intent of the present invention. The reports module may be accessed by selecting a reports icon on the display 110.

The reports module may be utilized to generate continuous market research. The market research may be performed by hour, day, week, month, year and/or any other time period. For example, the location of a first product 140 over time may be compared to a second product over time. In this manner, the comparison may be utilized to determine a shopper's preference for the first product 140 versus the second product. Moreover, the research may be performed per shelving unit 102, per store, per location, per state, and/or per country. The interactive display system 100 allows for demographics and merchandizing without ever having to ask a shopper 122 a question because the interactive display system 100 may monitor a shopper's interaction with RFID tagged product 104 and/or shelving units 102. The reports module may generate reports regarding details as small as the best shelf location for purchases. Further, the reports may be updated in real time, may perform continuous jobs, and/or may generate time scheduled reports, such as every hour, day, week, month year and/or any other time period. Further, location specific data may be helpful in analyzing merchandising trends, product placement, and/or promotional products.

The card 130 may be utilized by the retailer to track her sales associates, the number of sales generated by each sales associate, and/or the number of times a sales associate helps a shopper 122. This list is not restrictive. It is contemplated that other functions may be utilized by the card 130 within the limitations of the interactive display system 100 and the card's memory without departing from the scope and intent of the disclosure.

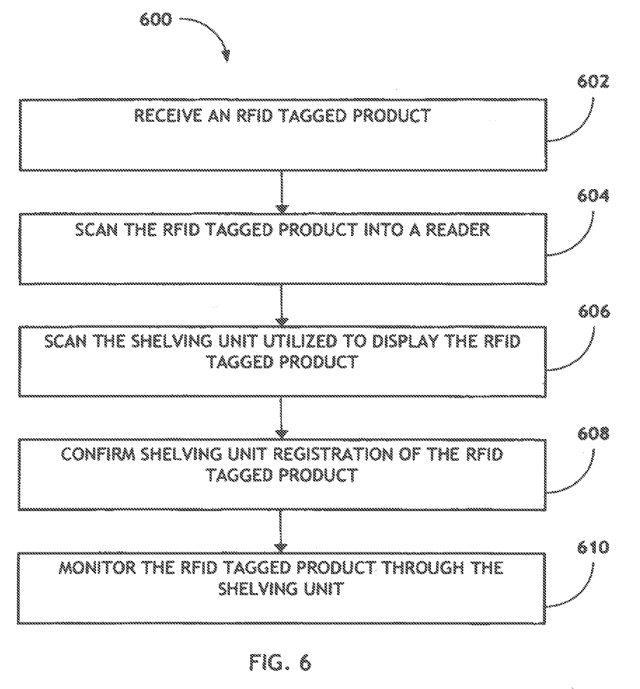

Referring to FIGS. 6 through 10, a block diagram of a decision method for an interactive display system 100 is shown.

Referring to FIG. 6, a block diagram of a decision process for registering an RFID tagged product to a shelving unit 600 is shown. Method 600 receives an RFID tagged product, 602. Method 600 scans the RFID tagged product into a reader, 604. Method 600 scans the shelving unit utilized to display the RFID tagged product, 606. Method 600 confirms shelving unit registration of the RFID tagged product, 608. Method 600 monitors the RFID tagged product through the shelving unit, 610.

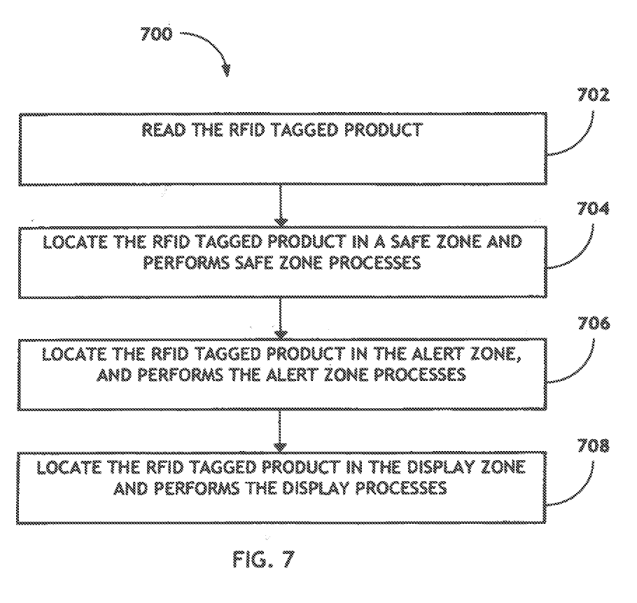

Referring to FIG. 7, a block diagram of a method for monitoring the RFID tagged product by the shelving unit 700 is shown. Method 700 reads the RFID tagged product, 702. Method 700 locates the RFID tagged product in a safe zone 134 and performs safe zone processes, 704. Method 700 locates the RFID tagged product in the alert zone, and performs the alert zone processes, 706. Method 700 locates the RFID tagged product in the display zone 136 and performs the display processes, 708.

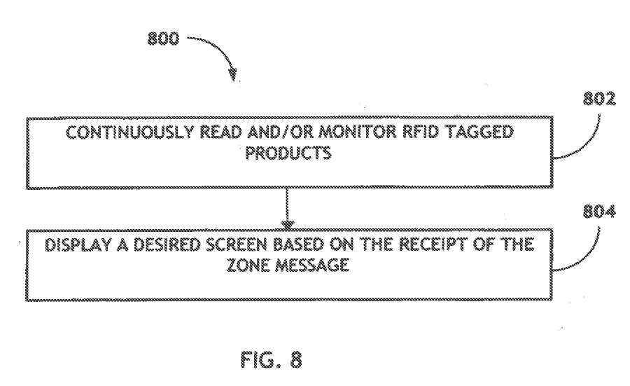

Referring to FIG. 8, a block diagram illustrating a safe zone process 800 is shown. Method 800 continuously reads and/or monitors RFID tagged products, 802. Method 800 sends a safe zone message to the display 110. Method 800 displays a desired screen based on the receipt of the zone message, 804.

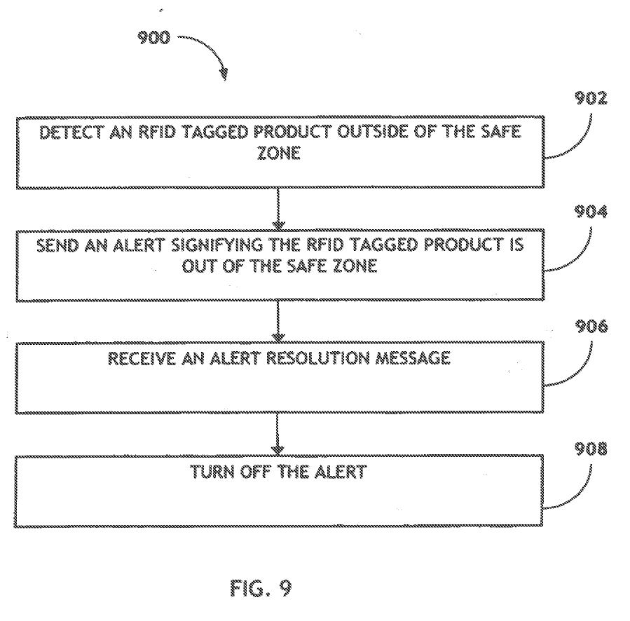

Referring to FIG. 9, a block diagram of an alert process 900 is shown. Method 900 detects an RFID tagged product outside of the safe zone, 902. Method 900 sends an alert signifying the RFID tagged product is out of the safe zone, 904. Method 900 receives an alert resolution message, 906. Method 900 turns off the alert, 908.

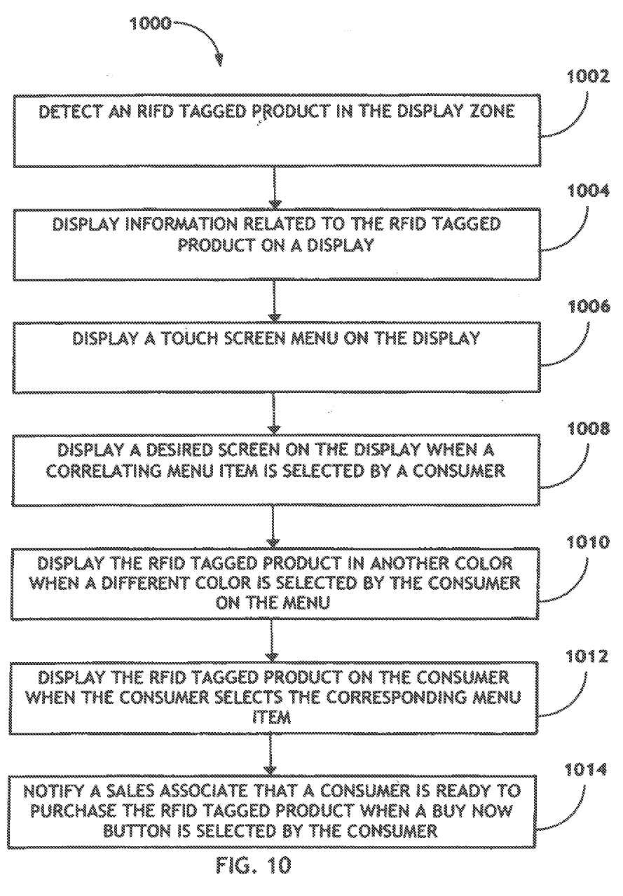

Referring to FIG. 10, a display process 1000 is shown. Method 1000 detects an RIFD tagged product in the display zone, 1002. Method 1000 displays information related to the RFID tagged product on a display, 1004. Method 1000 displays a touch screen menu on the display, 1006. Method 1000 displays a desired screen on the display 110 when a correlating menu item is selected by a shopper, 1008. Method 1000 displays the RFID tagged product in another color when a different color is selected by the shopper on the menu, 1010. Method 1000 displays the RFID tagged product on the shopper when the shopper selects the corresponding menu item, 1012. Method 1000 notifies a sales associate that a shopper is ready to purchase the RFID tagged product when a buy now button is selected by the shopper, 1014.

Methods 800, 900, and 1000 may be utilized by method 700. Moreover, methods 600 and 700 may be performed consecutively. Furthermore, a single shelving unit and/or the interactive display may perform methods 600, 700, 800, 900, and/or 1000. The shelving unit 102 and/or the interactive display may perform at least two of the methods 700, 800, 900, and 1000 simultaneously.

The interactive display system 100 may further comprise a wireless tablet. The wireless tablet may be a Bluetooth enabled tablet. The tablet may be placed anywhere within the shelving unit 102 or within a set distance of a shelving unit 102 and/or an antenna 116. The shelving unit 102 may be associated with a monitor. When a product is placed on the tablet an event may be triggered. The triggered event may alert an application host to activate the display 110. The activated display 110 may show additional information, sales, and/or accessories of the product placed on the tablet. The additional information may comprise specifications about the product, pictures of the product, and/or price information on the product. The tablet may also be utilized for checkout. The table may ring up any RFID tagged product 104 that is placed upon the tablet for purchase. It is understood that any device which may accept commands in application programming interface (API) and dynamic-link library (DLL) may be incorporated within the interactive display system 100.

The zoning module comprises the implementation of in-store zoning. All of the zoning in the zoning module is predefined with associated business rules. As an RFID tag 114 crosses multiple zones different actions will be triggered by the zoning module. The zoning parameters and the defined business rules may be customized by the retailer. The zoning module may be configured to ring up an RFID tagged product 104 when an RFID tagged product 104 moves from one zone near a shelving unit 102 to another zone near a check out or sales station. The zoning module may be configured to send special coupons to the portable electronic device of a shopper 122 (e.g., a wireless telephone, personal data assistant) who moves a specific RFID tagged product 104 from one zone to another zone. This list is not restrictive. It is contemplated that any desired predefined business rules may be utilized by the zoning module within the constraints of the interactive display system 100 without departing from the scope and intent of the disclosure.

It is also contemplated that any of the functions performed by the interactive display system 100, the shelving unit 102, and/or the middleware system may be performed in real-time.

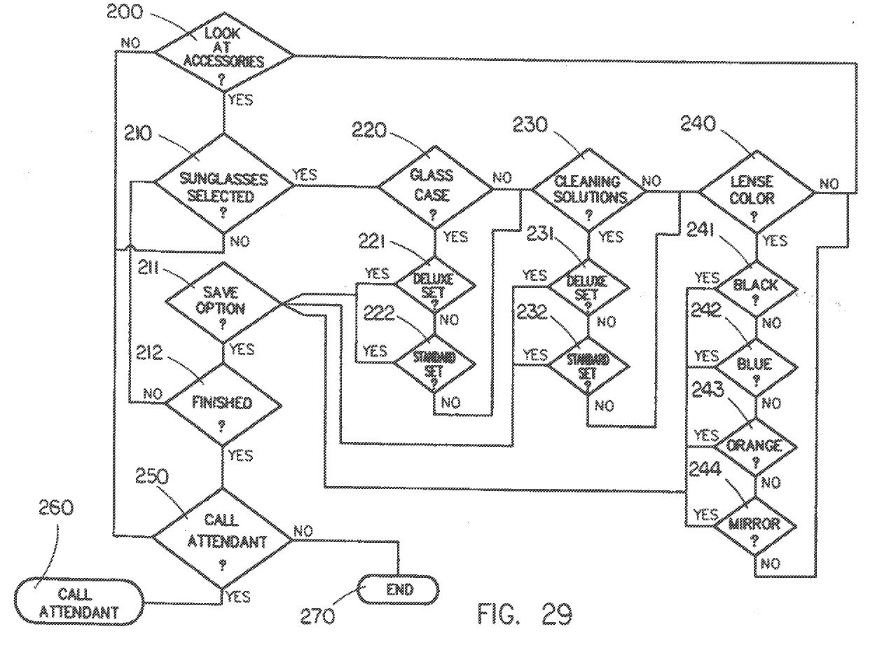

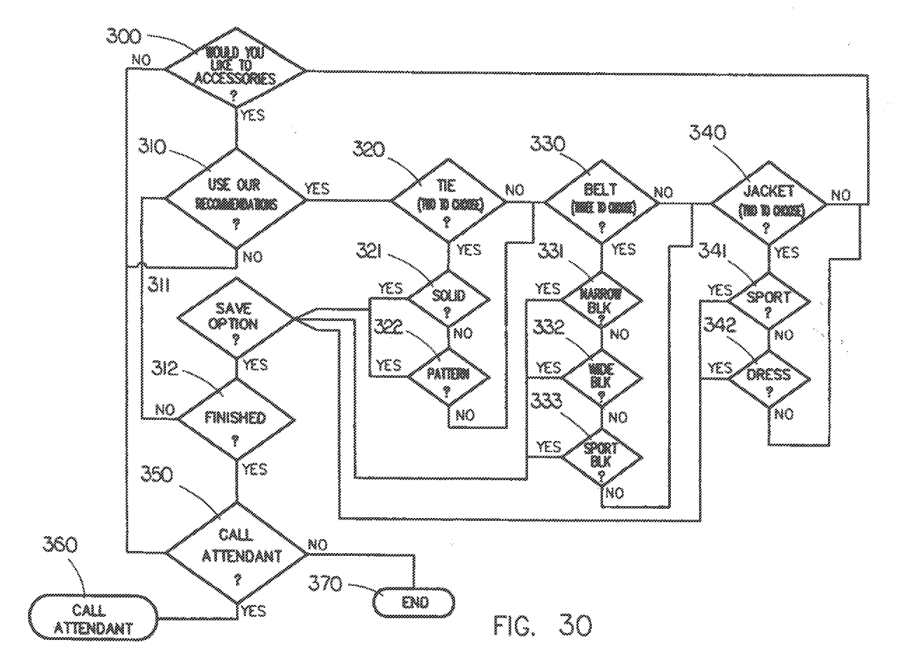

Referring to FIGS. 29 and 30, a block diagram of a decision method for an interactive display system 100 is shown.

Referring to FIG. 29, a block diagram of a decision process for purchasing an RFID tagged product from a shelving unit 102 is shown. The interactive display system 100 asks if a shopper 122 would like to look at accessories, 200. The interactive display system 100 asks if the shopper 122 has selected sunglasses, 210. The interactive display system 100 asks if the shopper 122 has selected a glasses case, 220. In this embodiment, the shopper 122 can select the one of the following glasses cases: the deluxe set 221 or the standard set 222. It is appreciated that a variety of glasses cases may be utilized with the present invention without departing from the scope and intent of the disclosure. The interactive display system 100 asks if the shopper 122 would like cleaning solution, 230. In this embodiment, the shopper 122 can select the one of the following options for cleaning solution: the deluxe set 231 or the standard set 232. It is appreciated that a variety of options for cleaning solution may be utilized with the present invention without departing from the scope and intent of the disclosure. The interactive display system 100 prompts the shopper 122 to select a lens color, 240. In this embodiment, the shopper 122 can select the one of the following lens colors: black 241, blue 242, orange 243, or mirror 244. It is appreciated that a variety of colors may be utilized with the present invention without departing from the scope and intent of the disclosure. At any point during the decision process the shopper 122 can select a save option 211, finish 212, or call attendant 250. In this embodiment, if the shopper 122 is asked if she would like to call attendant 250, the shopper 122 may either call attendant 260 or end 270. It is appreciated that a variety of service models and sales completion services may be utilized with the present invention without departing from the scope and intent of the disclosure. It is further appreciated that other accessories may be used, such as belts, eyeglass and sunglass frames, watches, jewelry, handbags, winter apparel, perfume, wireless telephones, personal data assistants, cameras, and other products as desired.

Referring to FIG. 30, a block diagram of a decision process for purchasing an RFID tagged product from a shelving unit 102 is shown. The interactive display system 100 asks if a shopper 122 would like to look at accessories, 300. The interactive display system 100 asks if the shopper 122 would use recommendations, 310. The interactive display system 100 asks if the shopper 122 would like to purchase a tie, 320. In this embodiment, the shopper 122 may be able to choose whether the tie is solid 321 or has a pattern 322. It is appreciated that a variety of tie options may be utilized with the present invention without departing from the scope and intent of the disclosure. The interactive display system 100 asks if the shopper 122 would like to purchase a belt, 330. In this embodiment, the shopper 122 may be able to choose whether the belt is narrow black 331, wide black 332 or sport black 333. It is appreciated that a variety of belt options may be utilized with the present invention without departing from the scope and intent of the disclosure. The interactive display system 100 asks if the shopper 122 would like to purchase a jacket, 340. In this embodiment, the shopper 122 may be able to choose whether the jacket is a sport 341 or a dress 342 jacket. It is appreciated that a variety of jacket options may be utilized with the present invention without departing from the scope and intent of the disclosure. At any point during the decision process the shopper 122 can select a save option 311, finish 312, or call attendant 250. In this embodiment, if the shopper 122 is asked if she would like to call attendant 350, the shopper 122 may either call attendant 360 or end 370. It is appreciated that a variety of service models and sales completion services may be utilized with the present invention without departing from the scope and intent of the disclosure. It is further appreciated that other accessories may be used, such as eyeglass and sunglass frames, watches, jewelry, handbags, winter apparel, perfume, wireless telephones, personal data assistants, cameras, and other products as desired.

Decision methods 200 and 300 may be performed consecutively. Furthermore, a single shelving unit and/or the interactive display may perform methods 200 and/or 300. The shelving unit and/or the interactive display may perform the methods 200 and 300 simultaneously.

The methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the disclosure. The accompanying method claims present elements of the various steps in a sample order, and are not necessarily meant to be limited to the specific order or hierarchy presented.

It is believed that the interactive display system of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

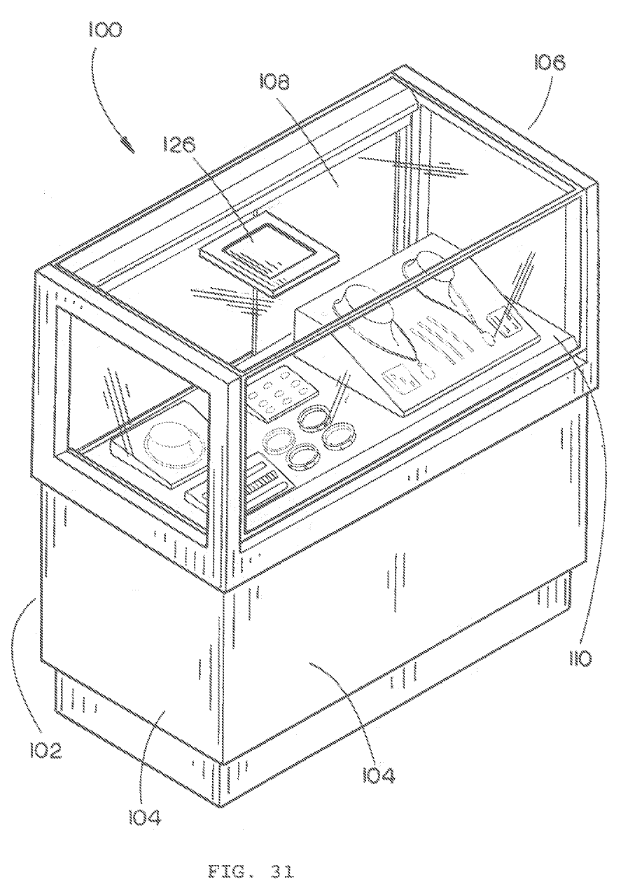

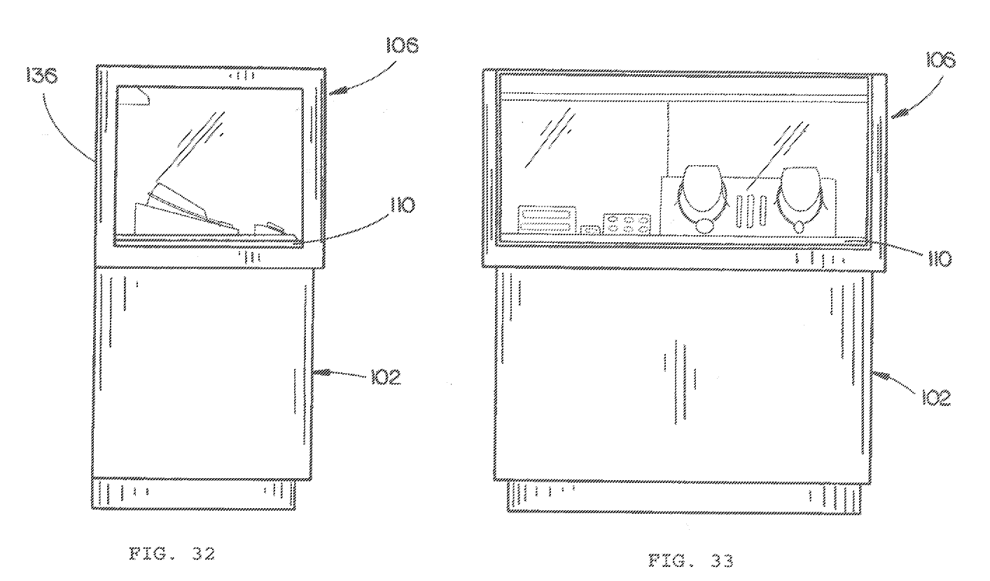

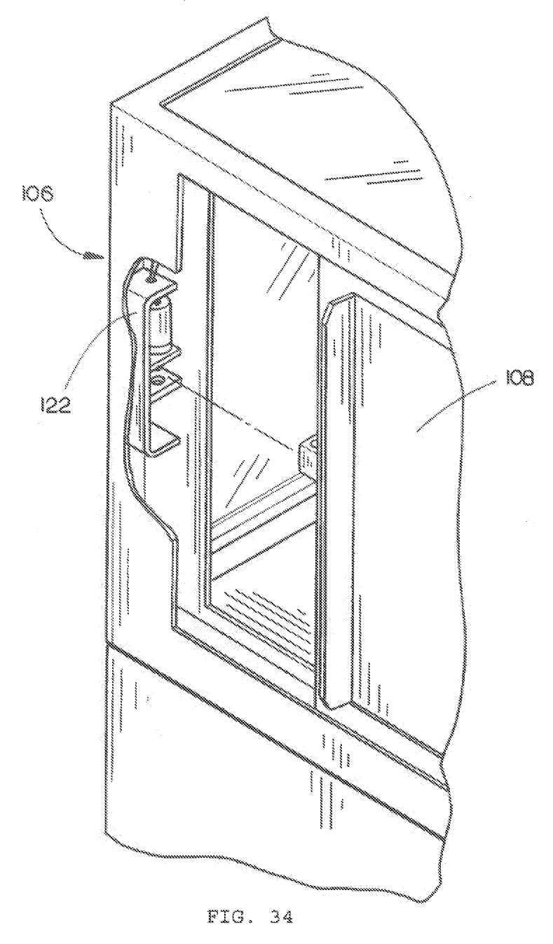

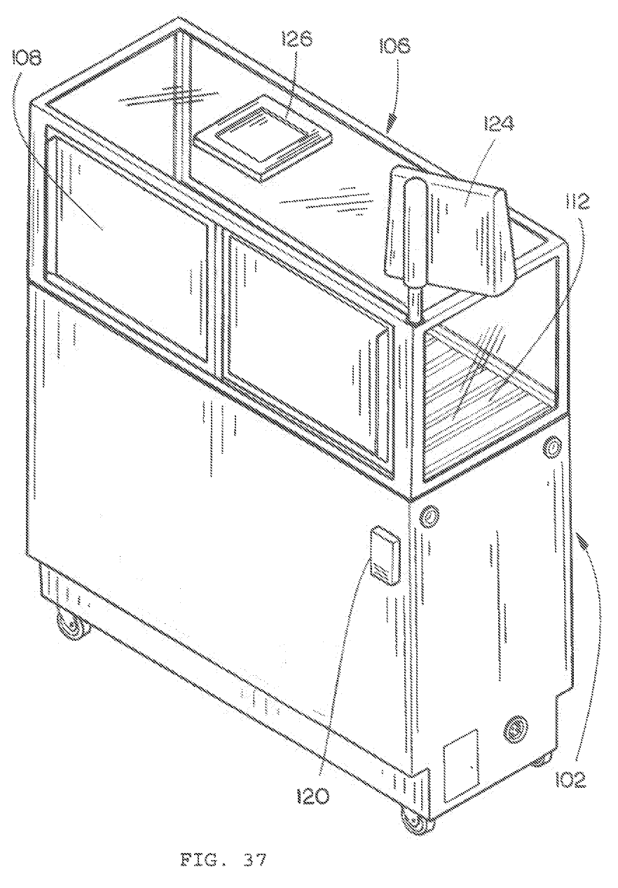

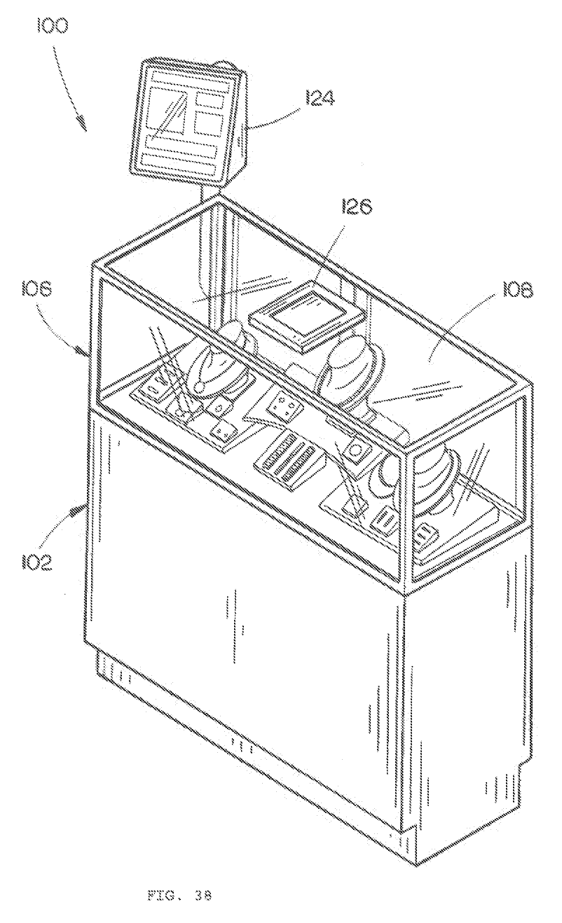

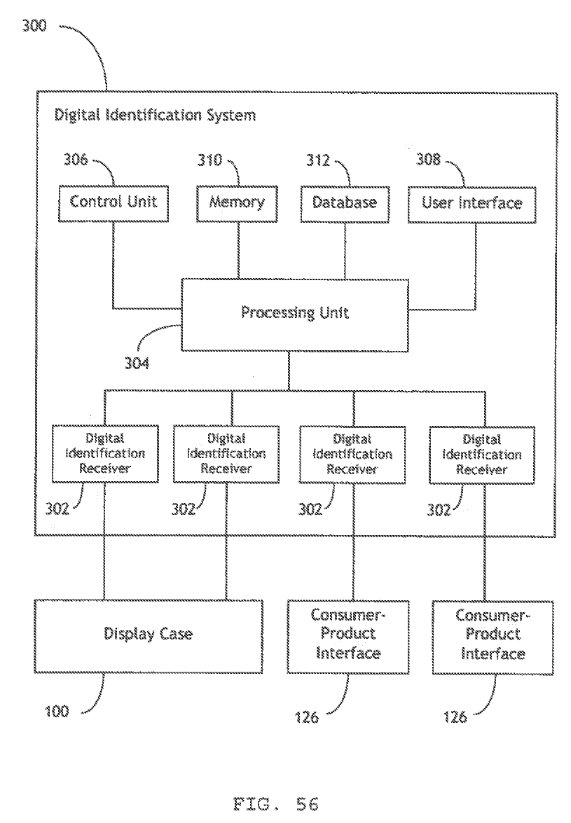

Referring generally to FIGS. 31 through 38 and 56, a multiple security level display system including a display case 100, a consumer-product interface 126 and a digital identification system 300 is described in accordance with the present disclosure.

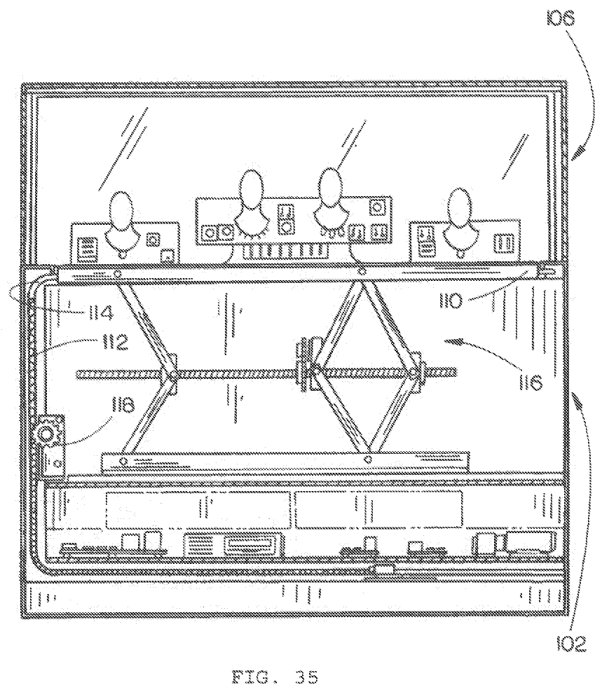

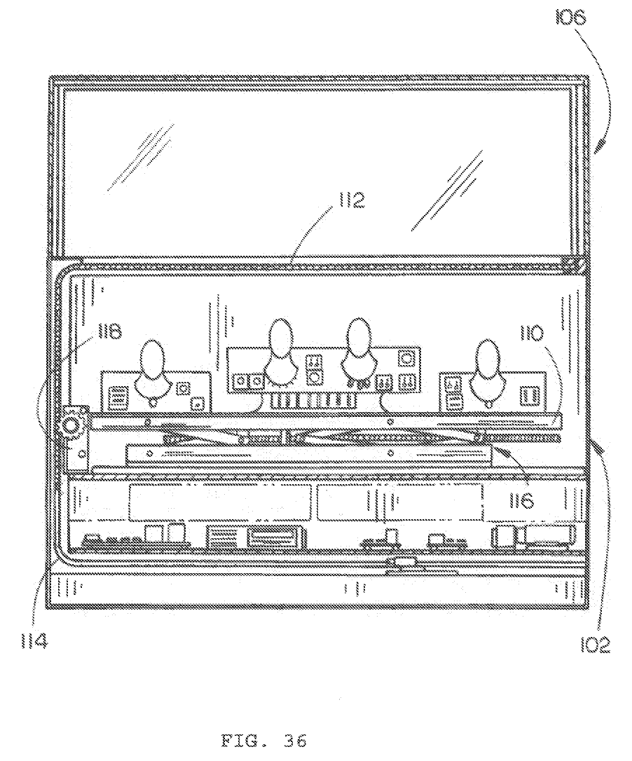

The display case 100 may include a storage area 102 and a display area 106 adjoining the storage area 102. The storage area 102 may be defined by a plurality of side walls 104. The display area 106 may include one or more doors 108 for accessing the display area 106. A product exhibit device (e.g., a platform or a display shelf) 110 may be utilized for supporting one or more products for display. The exhibit device 110 may be configured to be movable between a display position (as illustrated in FIG. 35) at least substantially within the display area 106, and a storage position (as illustrated in FIG. 36) within the storage area 102. The display case 100 may also include a movable storage area cover 112. The movable storage area cover 112 is positioned at an open position when the exhibit device 110 is positioned at the display position (as illustrated in FIG. 35). When the exhibit device 110 is positioned in its storage position, the movable storage area cover 112 may be placed between the display area 106 and the storage area 102 to separate the display and the storage areas (as illustrated in FIG. 36). The storage area cover 112 and the side walls 104 defining the storage area may form a secure enclosure.

The multiple security level display system also includes one or more consumer-product interface 126. In one embodiment, the consumer-product interface 126 is a viewing tray configured for temporarily receiving one or more items/products removed from the display case 100 to facilitate customer viewing of the items. The viewing tray may be portable or affixed to the display case 100.

Identification tags may be attached to the products in the display case. Each tag may be configured for providing a product-specific identification signal. An identification signal may be presented as an electromagnetic signal, a Radio Frequency Identification (RFID) signal, or the like. The identification signal may be a digital signal. In one embodiment, one or more Radio Frequency Identification (RFID) tags may be attached to a product. An RFID tag may be fixedly attached to a product by means of a strap, zip tie, adhesive, screws, snaps, and/or staples. The RFID tag may also be contained within a product and/or manufactured as part of a product. It is contemplated that there are a variety of ways to attach an RFID tag to a product without departing from the scope and intent of the present disclosure. It is further anticipated that an RFID tag may be attached to a product in a way that the RFID tag is not substantially visible when handled and/or worn by the shopper.

An RFID tagged product may transmit a product identification signal indicative of a product type and/or related product information. For example, one specific product type may include a family of products (e.g., a group of products having like form factors, product number, and/or monetary value). Alternatively, the product identification signal may be indicative of a single product (e.g., a product having a specific part number). Further, the product identification signal may be indicative of a characteristic of the product. For instance, the product identification signal may be indicative of a color, a decal, a design, a finish, a form factor, a hue, a material, a pattern, a shape, a size, a style, a texture, and/or a tint.

The digital identification system 300 is communicatively coupled to the display case 100 and the consumer-product interface 126. The display case 100 may include one or more digital identification receivers 302 (e.g., RFID readers) for receiving digital identification signals. For example, one or more RFID readers 302 may be positioned on the exhibit device 110 and configured for receiving product identification signals from the RFID tagged products. The consumer-product interface 126 may also include one or more RFID readers 302 for receiving signals from RFID tagged products placed on the consumer-product interface 126 during consumer viewing of an RFID tagged product.

The digital identification system 300 may include a processing unit 304. The RFID readers 302 may transmit the digital identification signals to the processing unit 304 via a wired connection (e.g., data cable) or a wireless connection (e.g., Wi-Fi or Bluetooth). The digital identification system 300 may include a control unit (control program) 306. The control unit 306 may include a set of control instructions to be executed on the processing unit 304 for operating the multiple security level display system in response to the digital identification signals received from the RFID readers 302. A user interface 308 may be provided for defining and/or modifying the set of control instructions for the control unit 306.

The digital identification system 300 may monitor/track movements and/or locations of the displayed items. For example, the digital identification system may determine whether an item is in the display case 100, the consumer-product interface 126, or not in either of the display case 100 or the consumer-product interface 126 (e.g., when an item is moved out of a detection range of the digital identification system).

For example, when an item from the exhibit device 110 is taken out of the display case 100 by a store employee for customer viewing, an RFID reader located on the display case 100 (e.g., embedded in the exhibit device) may sense the removal of this item from the exhibit device. The store employee may then place the item on the consumer-product interface 126 to facilitate customer viewing. The placement of the item on the consumer-product interface 126 may be sensed by an RFID reader located on the consumer-product interface 126. Similarly, when the item is ready to be returned to the display case 100, the RFID reader located on the consumer-product interface 126 may sense the removal of the item from the consumer-product interface, and the RFID reader located on the display case 100 may sense the placement of the item on the product exhibit device.

The control unit 306 may include a set of security rules defined based on the movements and/or locations of the items. Security rules may be defined to mitigate chances of displayed items being lost or stolen. For example, if an item is removed from the display case 100 without being placed on the consumer-product interface 126 or returned to the display case 100 for a predefined period of time (e.g., 15 seconds) or longer, a security alert (alarm) may be issued. Similarly, if an item is moved away from the consumer-product interface 126 without being returned to the display case 100 or placed on the consumer-product interface 126 again for a predefined period of time or longer, a security alert (alarm) may be issued. It is contemplated that the security alert may be an audio alert or a visual alert. The security alert may also be transmittable to at least one of a portable or a stationary security monitoring device. For example, the security alert may be transmittable to one or more portable devices (e.g., PDAs or pagers) carried by security personnel. In another example, the security alert may be transmittable to a security monitor located in a remote location.

The control unit 306 may also utilize the movements and/or locations of the items to enhance customer shopping experiences. For example, an information display 124 may be positioned in proximity to the display case 100 for providing an interactive shopping interface. When an item is placed in the consumer-product interface 126, the digital identification system 300 may detect/identify the item based on the RFID tag attached to the item, allowing the information display 124 to provide product information regarding this particular item. Such product information may include, but is not limited to, pricing, availability, sizes, colors, current stock (e.g., in-store, in-warehouse, etc), etc. The information display 124 may also provide product information regarding other items that may be related to the item placed on the consumer-product interface 126. For example, if a necklace is currently placed on the consumer-product interface 126, product information regarding matching earrings may be suggested and displayed on the information display 124. In another example, payment schedule, gift wrap and other related information may be provided based on the item placed on the consumer-product interface.

It is understood that the information display 124 may also provide other types of interfaces without departing from the scope and spirit of the present disclosure. The information display 124 may be configured as an interactive display device (e.g., a touch screen monitor). The information display 124 may provide a product catalog interface which may allow customers to view product information while waiting to be assisted. In another example, the information display 124 may be configured for providing the user interface 308 when operated by a store employee.

The movements and/or locations of the displayed items may also be utilized for marketing analysis purposes. The locations of each RFID tagged item may be recorded/logged in data storage mediums such as a memory 310 or a database 312. A report module may be provided that allows a retailer to view a pre-defined and/or customized report. The report module may utilize correlation software to generate reports. The reports module may generate reports based on the number of sales; how often an RFID tagged product is selected, moved, and/or purchased; and/or the number of alerts generated per shelving unit, per interactive display system, per store, per locality, and/or per region. The reports module may generate reports comparing the information generated from one RFID tagged product to another RFID tagged product. This list is not restrictive. It is understood that any desired report may be generated by utilizing any of the information recorded and/or generated without departing from the scope and intent of the present invention. The report module may be accessed and configured via the user interface 308.

It is contemplated that, under certain circumstance, an item may be permitted to be moved out of the detection range of the digital identification system 300 for an extended period of time without triggering the alarm. For example, upon removal of an item from the consumer-product interface 126, the item may be expected to be returned to the display case 100 within a predetermined period of time (e.g., 15 seconds). However, a customer may request to briefly wear the item, in which case the item may not be returned to the display case within the predetermined period of time. In such situations, the alarm may be configured to be delivered only to store employees without disturbing the customer. Alternatively, an alarm overriding logic for temporarily disabling the alarm may be activated by a store employee attending the customer. Such an alarm overriding logic may be activated by the store employee, for example, prior to handling the item to the customer, during the period when the customer has the possession of the item, or after the alarm has been issued.

Furthermore, a camera may be utilized for capturing images of the display system and its surroundings. For example, the camera may start capturing images when the item is moved away from the consumer-product interface 126. Such images may be recorded and/or delivered to a security monitoring station. Alternatively, the camera may capture images for the duration between the removal of an item from the display case 100 and the return of the item to the display case 100. It is understood that the camera may be configured to capture images under other capturing rules.

The captured images may be further processed to collect attributes of a customer. For example, image processing/recognition techniques may be utilized to detect physical attributes of the customer. The physical attributes may include the customer's body type, complexion, eye color, face shape, gender, hair color, height, skin tone and/or weight, among other things. In another embodiment, the camera may sense customer interaction and collect behavioral characteristics of the customer and record the collected information in memory 310. The behavioral characteristics may include browsing history, gift buying history, promotional purchasing profile, purchasing profile and/or seasonal buying profile.

The multiple security level display system may further utilize the business intelligence collected from the customer (e.g., physical attributes and/or behavioral characteristics) to create an optimal sales atmosphere, and/or to personalize interaction with the customer. In one embodiment, business intelligence may be used to determine optimal product placement, pinpoint an ideal price for the sale of a product, create a database of customer preferences, generate an ideal customer profile, determine an optimal display case location, tailor merchandise suggestions to a specific customer or a type of customer, increase the attractiveness of a display, record the ratio of male to female shoppers, track which accessories are purchased with each product, and/or create targeted advertisements, among other things.

Additional security features may also be provided utilizing the digital identification system 300. For example, the digital identification system may be configured for conducting an inventory of items in the display case 100, controlling the position of the exhibit device 110, and/or controlling access to the display case 100.

The digital identification system 300 may be configured for conducting an inventory of items in the display case 100. For example, RFID tags attached to items placed in the display case may be configured for providing item-specific radio frequency signals. Such a signal may be configured for identifying an item and/or related product information. The digital identification system 300 may conduct an inventory of items by detecting the presence of the RFID tags periodically. If an item was detected previously but is currently undetected (missing), an alarm may be issued. Alternatively, the digital identification system 300 may conduct an inventory of items each time the exhibit device 110 changes its position (e.g., from storage position to display position, or vice versa). Furthermore, the digital identification system may conduct an inventory of items on demand. It is contemplated that an item sold between two consecutive inventory cycles may be identified as such, and therefore not be considered as a missing item.

The digital identification system 300 may monitor the quantities of products and/or may automatically order new products when a certain number is reached. The digital identification system may notify the retailer by an alert that a certain product is low in stock, needs to be restocked, and/or is out of stock when a certain number is reached. The digital identification system may monitor the quantities of products, automatically cancel orders and/or send orders when a certain number is reached. The digital identification system may notify the retailer by an alert that a certain product is overstocked when a certain number is reached.

The digital identification system 300 may also be configured for controlling the position of the exhibit device 110. For example, the exhibit device 110 may be lowered into the storage position at the close of business when an RFID key of an employee and/or security personnel is presented to the digital identification system. In another example, the exhibit device 110 may be raised into the display position at the opening of business when the RFID card of an employee and/or security personnel is presented to the digital identification system. Furthermore, the digital identification system may provide an emergency mode where the system may override all current operations to position the product exhibit device into the storage position.

The digital identification system 300 may also be configured for controlling access to the display case 100. For example, the door 108 for accessing the display area 106 may be controlled by an electronic lock 122 configured to operate in response to the digital identification system. For instance, employees may be equipped with RFID keys configured for accessing the display area 106 during a predefined time interval (e.g., during store hours). When an RFID key with access permission is presented to the digital identification system 300 during the predefined time interval, the digital identification system may temporarily release the electronic lock 122. However, the digital identification system may deny the employee access to the display area 106 if the RFID key presented does not have proper access permission, and/or the time that the RFID key is presented is not within the predefined time interval associated with this particular RFID key (e.g., an employee trying to access the display are 106 outside of the store operating hours).

An RFID key may include an active or passive RFID tag embedded in an item associated with an employee. An active tag may include a power supply (e.g., a battery) and may transmit signals autonomously. A passive tag may require an external source to provoke signal transmission. For example, a passive RFID tag may be embedded in an employee badge. In another example, an active RFID tag may be embedded in a phone/pager carried by the employee. Different RFID keys may be configured with different access permissions and/or different time intervals for operation. In one embodiment, the different access levels may be defined based on accessible time intervals, user authentications, or security levels of products in the display case.

For example, the access permission of an RFID key associated with a sales associate may be different from that of a store manager. For instance, the RFID key of the sales associate may not have permission to change the positions of the exhibit device for security reasons; the RFID key of the sales associate may be able to obtain access the display area 106 only after the exhibit device has been placed in the display position by a store manager.

In another example, the RFID tag for each item placed in the display case 100 may be associated with a security level (e.g., a more valuable item may be associated with a higher security level). When the display case 100 is being access utilizing an RFID key associated with a lower level sales associate, the lower level sales associate may only be authorized to remove items under a certain authorized level. If an item with a security level above the authorized level is removed, an alarm may be issued. A higher level sales associate may be equipped with an RFID key having a different authorized level, and thus able to remove more valuable items.

It is contemplated that the digital identification system 300 may record/log at least a portion of all activities in data storage mediums such as a memory 310 or a database 312. Reports may be generated and/or developed based on the activities recorded. For example, the digital identification system 300 may log each time an RFID key is presented to the RFID readers. This data may provide information regarding “who performed what operation at which time”. In another example, the digital identification system 300 may log each time an item is removed from and/or returned to the display system. This data may be processed for reporting “popular items” based on frequency and/or duration of customer viewings. It is understood that other types of reporting and/or processing may be provided without departing from the scope and spirit of the present disclosure.

It is also contemplated that the display case 100 may include more than one RFID reader for receiving RFID signals. For example, an RFID reader may be embedded in the exhibit device 110 for receiving signals from RFID tags attached to the items; another RFID reader 120 may be affixed to the display case 100 so that it is more accessible for store employees. It is understood that the RFID reader 120 may be configured not to be clearly identifiable to customers (e.g., placed at a hidden location and/or disguised). Alternatively, as illustrated in FIG. 55, the RFID reader 120 may be separable from the display case 100 for placement in a remote location (e.g., a security monitoring station). The RFID reader 120 may be placed remotely from the display case 100 in a location such as behind a wall or a partition. The location may be disclosed to an employee/manager, but may be kept secret from others.

Referring now to FIGS. 31 through 38, a display case 100 is shown. The display case 100 may include a storage area 102 defined by a plurality of side walls 104. The side walls 104 may be substantially opaque.

The side walls 104 may also be steel-reinforced. The side walls may be covered with a decorative fascia such as a wood veneer or laminate (not shown). The display case 100 may include a display area 106 situated above the storage area 102. The display area 106 may include one or more doors 108 for accessing the display area 106. In one embodiment, the door for accessing the display area may be located on a panel 136 of the display area 106. The panel 136 may be located at a generally non-customer-facing side. The panel 136 may be substantially opaque.

The display case 100 may include a product exhibit device (e.g., a platform or a display shelf) 110 for supporting one or more articles/products. In one embodiment, the exhibit device 110 may be configured in a generally horizontal orientation. The exhibit device 110 may be configured to be movable between a display position (as illustrated in FIG. 35) at least substantially within the display area 106, and a storage position (as illustrated in FIG. 36) within the storage area 102. The exhibit device 110 may be conditionally positioned in either of the display position or the storage position utilizing a lift mechanism 116. The exhibit device 110 may be configured in a horizontal, vertical, and/or diagonal orientation. The exhibit device 110 may support the products mechanically, gravitationally, magnetically, or electro-magnetically.

The display case 100 may include a movable storage area cover 112. The movable storage area cover 112 is positioned at an open position when the exhibit device 110 is positioned at the display position (as illustrated in FIG. 35). When the exhibit device 110 is positioned in its storage position, the movable storage area cover 112 may be placed in a closed position between the display area 106 and the storage area 102 to separate the display and the storage areas (as illustrated in FIG. 36). The storage area cover 112 and the side walls 104 defining the storage area may form a secure enclosure. In one embodiment, the movable storage area cover 112 may be configured as a tambour, movable along a track 114 defined along a portion of the storage area 102. The tambour may be driven by a motor 118 fixedly coupled to the storage area and connected to the tambour for moving the tambour between the open and closed positions.

It is contemplated that there are a variety of ways to assemble the display case 100. The parts of the display case 100 may be rearranged so that retailers may have a variety of product display options. Additionally, it is anticipated that the parts of the display case 100 may be removed so that parts can be easily fixed, replaced and/or reinstalled.

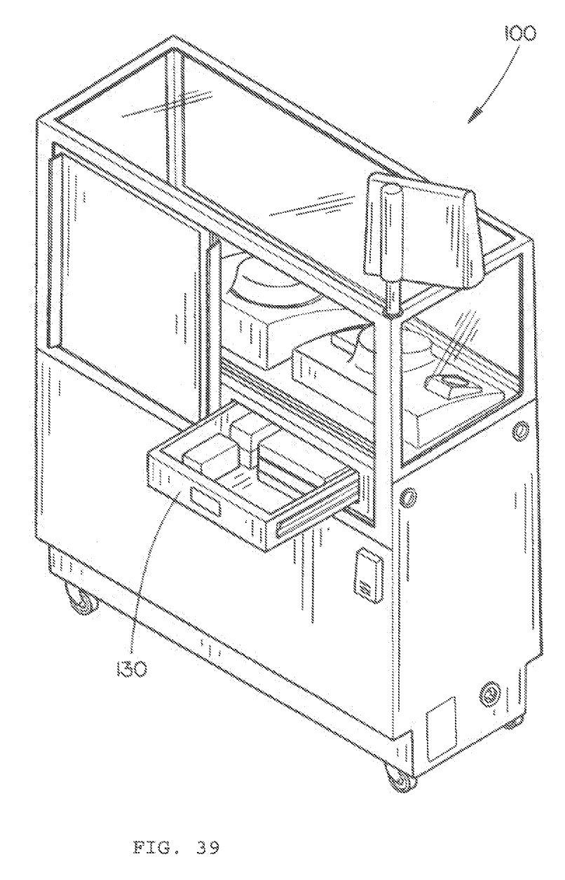

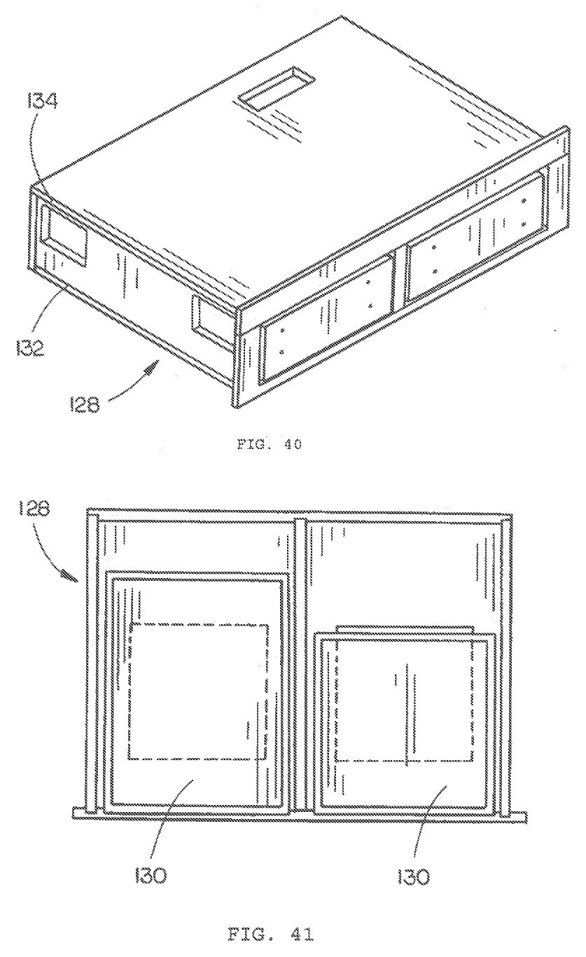

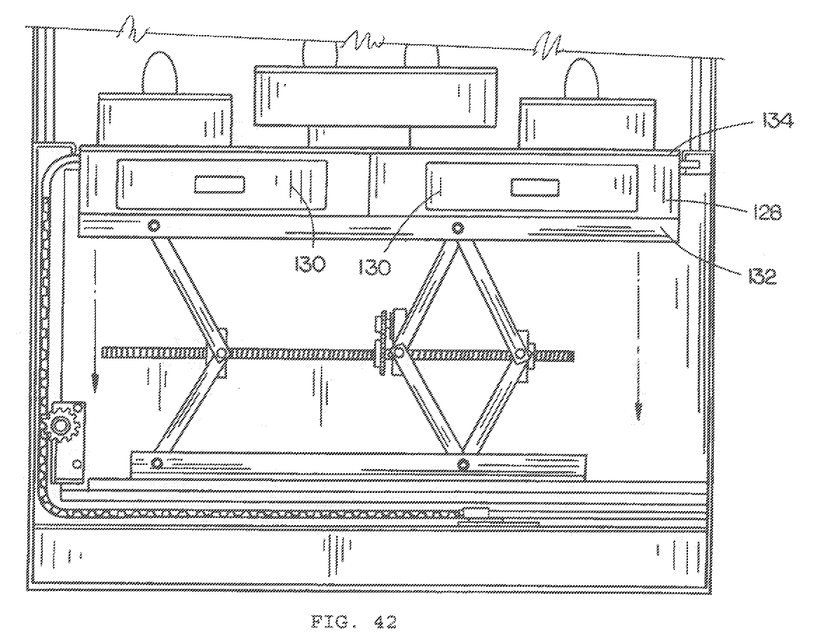

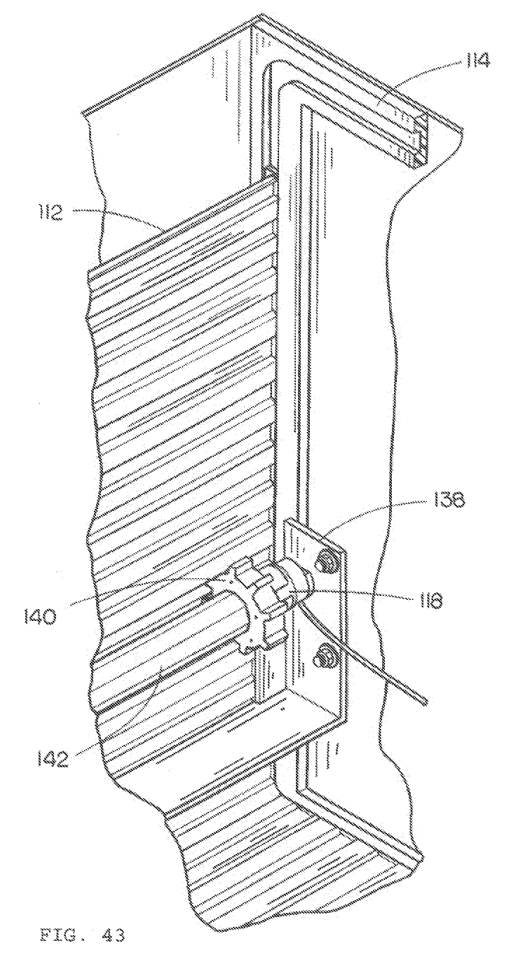

Referring now to FIGS. 39 through 42, an alternative embodiment of the exhibit device is shown. The exhibit device may comprise a storage compartment 128, where the storage compartment 128 may comprise a lower surface 132 for coupling to the lift mechanism and an upper surface 134 for supporting the at least one product for display. The storage compartment 128 may be accessible through a door 108 when the exhibit device is in the display position as illustrated in FIG. 9. The storage compartment 128 may be configured to be inaccessible when the exhibit device is in the storage position. It is contemplated that the storage compartment 128 may comprise one or more drawers 130. For example, the storage compartment 128 may include one or more items for refilling and/or replenishing stock displayed in the display case 100.

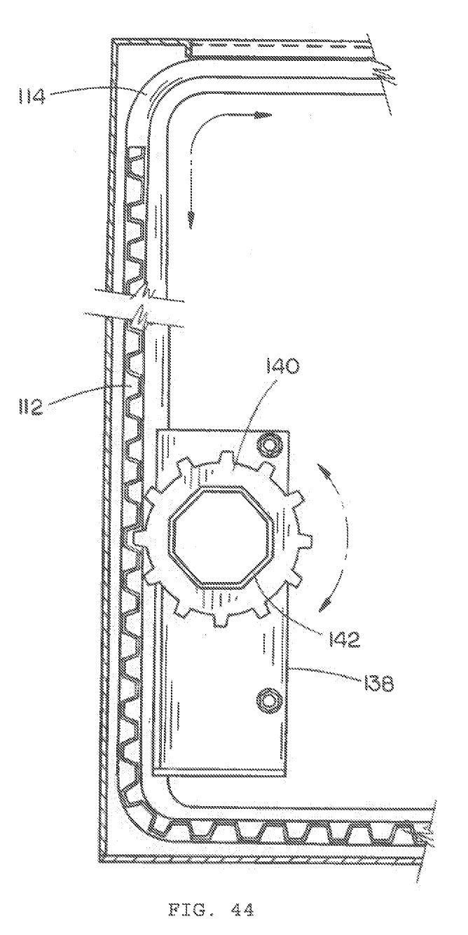

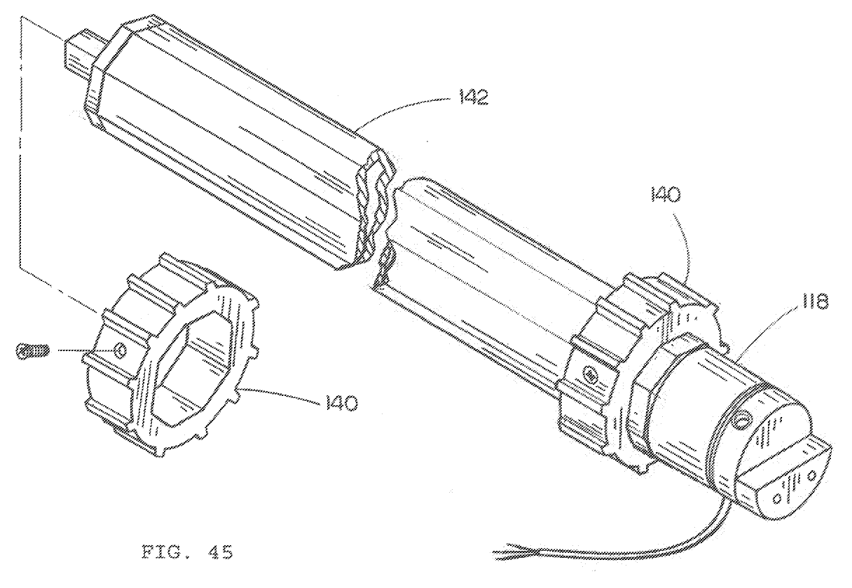

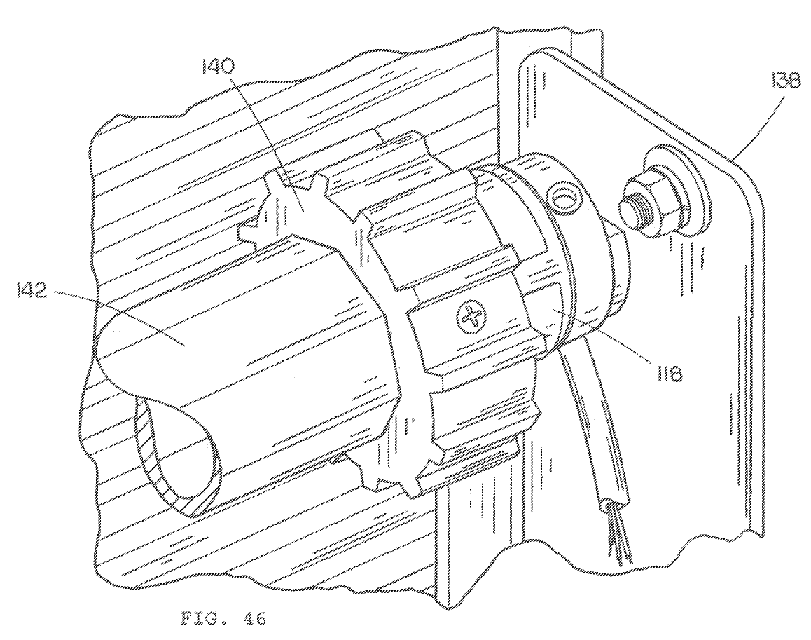

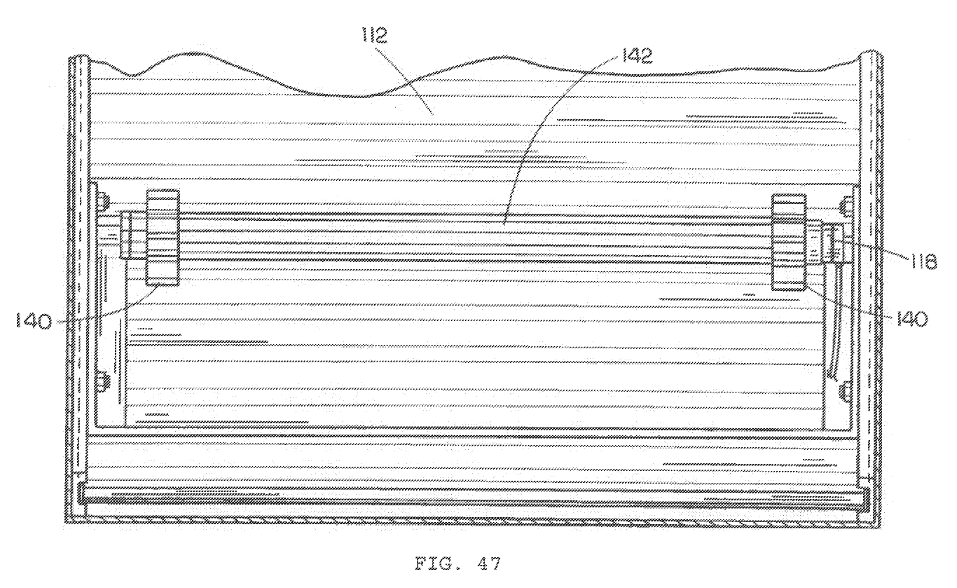

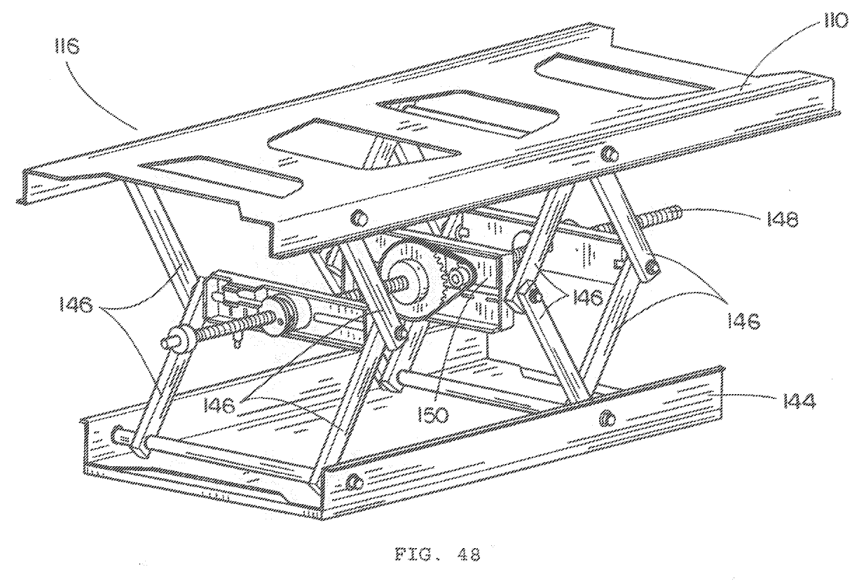

Referring now to FIGS. 43 through 47, a storage area cover assembly is shown. In one embodiment, the movable storage area cover 112 may be configured as a tambour movable along a plurality of tracks 114 defined along a portion of the storage area. A motor 118 (e.g., an electrical motor) may be fixedly coupled to the storage area via a mount 138. The motor 118 may be configured for providing powered rotational motion to a cylinder 142 coupled with one or more pinions 140. The pinions 140 may engage the cover 112 in a rack-and-pinion configuration and apply the rotational motion provided by the motor 118 to translational motion to move the cover 112 along the tracks 114. It is understood that other types of storage area covers may be employed without departing from the scope and spirit of the present disclosure.

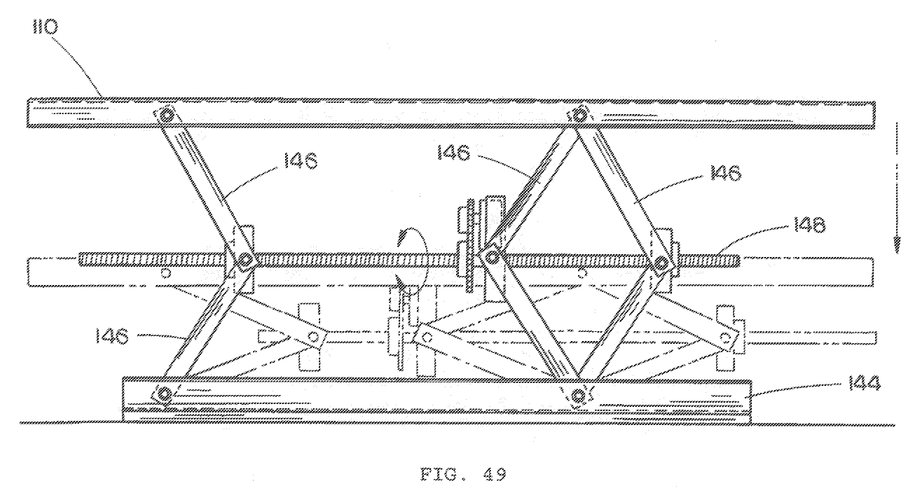

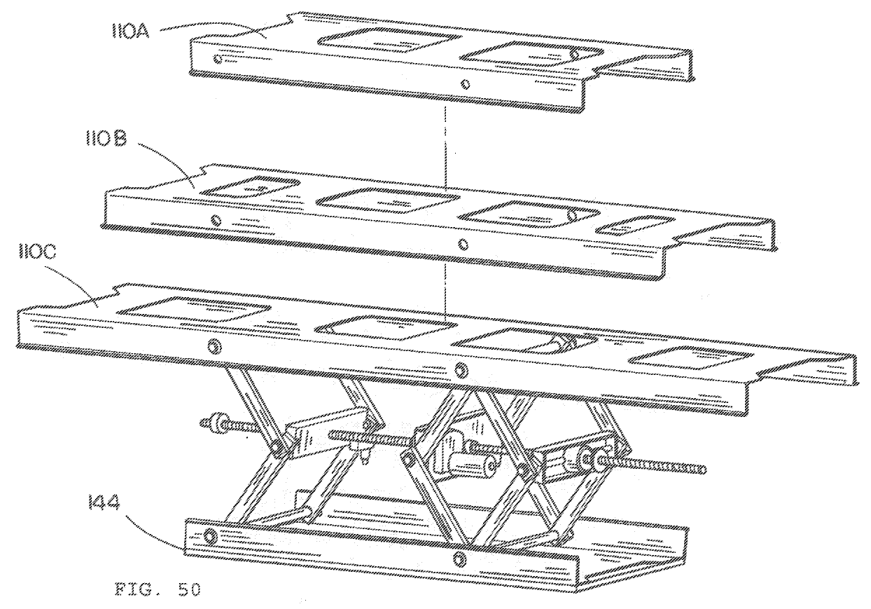

Referring now to FIGS. 48 through 50, a lift mechanism 116 is shown. In one embodiment, the lift mechanism 116 may be configured as a scissor-lift mechanism. The lift mechanism 116 may be disposed of the storage area and coupled to the exhibit device 110. The lift mechanism may be powered by electrical, pneumatic, or hydraulic power. The lift mechanism 116 may comprise a mount base 144 fixedly coupled to the storage area. The mount base 144 may support a plurality of scissor-lift arms 146 coupled to the exhibit device 110. An axle 148 may be rotatably coupled to (e.g., utilizing a belt or gears) a motor 150 for operating the scissor-lift arms 146. As illustrated in FIG. 49, rotation of the axle 148 may raise or lower the scissor-lift arms 146, positioning the exhibit device between the display position (as illustrated in solid lines in FIG. 49) and the storage position (as illustrated in phantom lines in FIG. 49). It is understood that other types of lift mechanisms may be employed without departing from the scope and spirit of the present disclosure.

It is contemplated that exhibit devices of different dimensions may be utilized for different display cases. For example, as illustrated in FIG. 50, a first exhibit device 110A having a shorter width may be utilized for a smaller display case while a second, wider exhibit device 1106 may be utilized for a wider display case. Similarly, a third, still wider exhibit device 110C may be utilized for a still wider display case. In this manner, only the exhibit device may need to be changed for supporting different shapes of display cases while the rest of the lift mechanism may remain unchanged.

In one embodiment, the top surface of the exhibit device 110 facing the display area may be utilized as the display shelf for supporting items to be displayed. Alternatively, additional elements may be utilized to form the product exhibit device. For example, a shelf surface may be placed/secured on top of the exhibit device 110. It is contemplated that the dimension (e.g., width and/or length) of the shelf surface may or may not be different from that of the exhibit device 110. It is also contemplated that the shelf surface may be configured as a multi-piece assembly as illustrated in FIG. 51. For example, the multi-piece shelf surface assembly may comprise a shelf base 152 to be secured on to the exhibit device 110. The shelf base 152 may define the dimension of the product exhibit device. Additional surface elements 154 may then be placed on the top to form the surface of the product exhibit device.

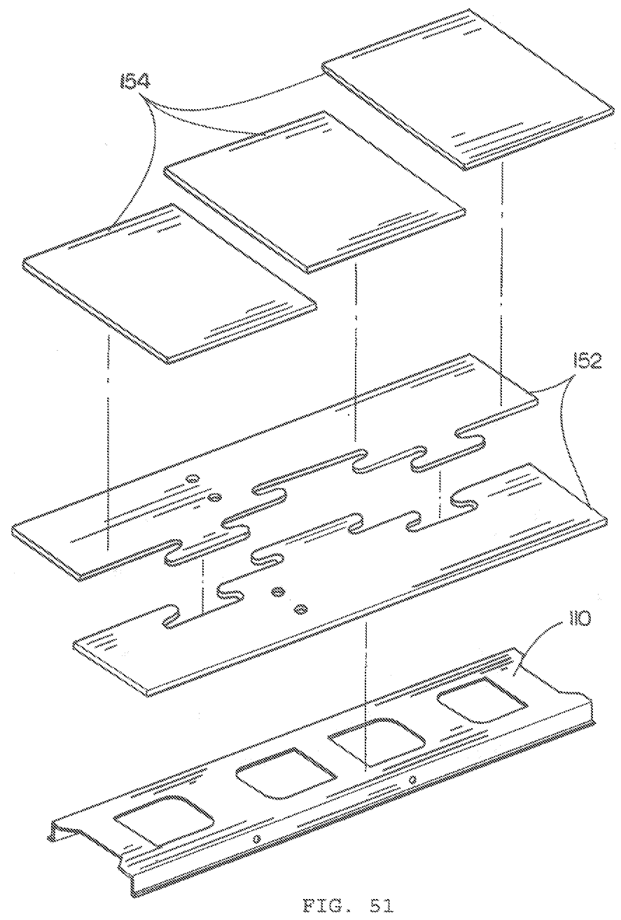

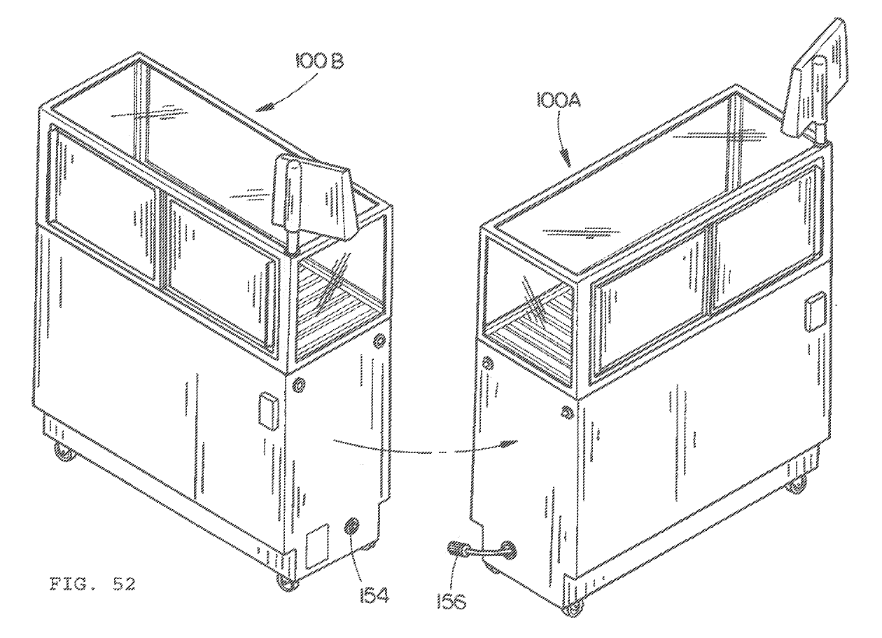

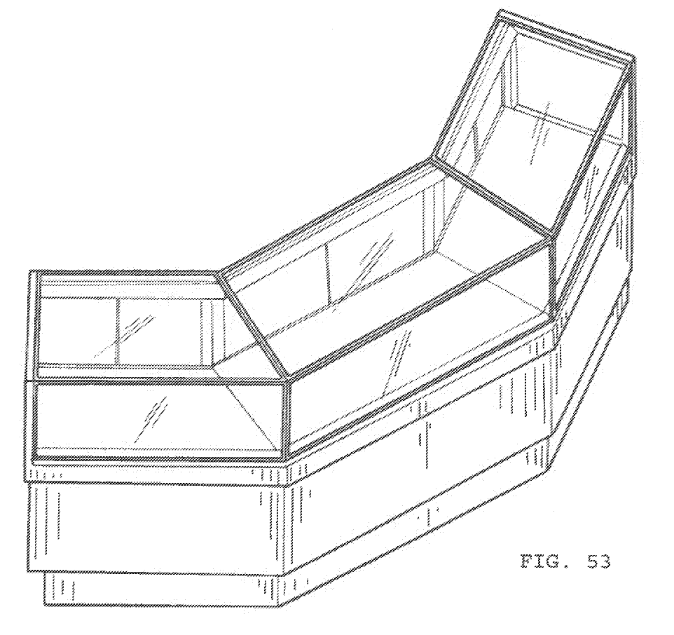

In one embodiment, as depicted in FIG. 52, the secure display system may comprise an inlet 154 for receiving electricity for powering the display system. The secure display system may further comprise an outlet 156 for providing electric connection to other systems. For example, two display systems 100A and 100B may be connected by connecting the inlet of system 100B to the outlet of system 100A. It is contemplated that data communications may also be provided in a similar manner. For example, the secure display system may comprise a data input for receiving data and a data output for transmitting the received data to another display system. In this manner, a store manager may have the option to issue a command for lowering the product exhibit device into the storage position at a particular display system once, and the command may be received at all connected display systems. In this manner, all connected display systems may lower their display shelves in response to the command. It is understood that the data communications may be provided via data cables through the inlet 154 and the outlet 156, or through separate data input/output ports. It is also understood that the data communications may be provided through wireless communication means.

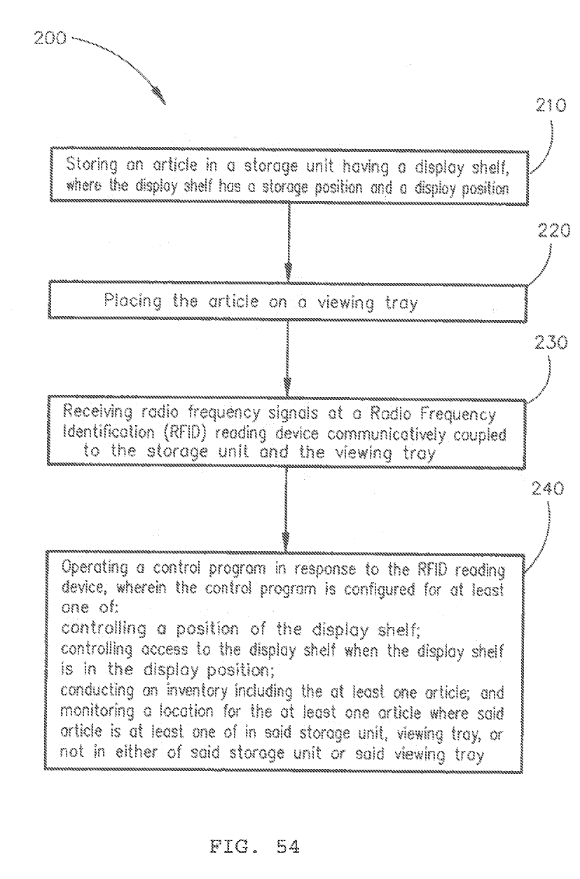

It is contemplated that the display cases may be modular as illustrated in FIG. 53. The display cases may be configured with different dimensions and may form different shapes and sizes. The display cases may be coupled mechanically and/or electronically. It is also contemplated that the display cases may comprise a back-up power supply. For example, back-up batteries and/or generators may be configured to automatically provide back-up power supply to the display cases in case of a failure of the main power source.

A service mode may be provided for maintaining/servicing the multiple security level display system. All operations and security features of the system may be temporarily disabled when the service mode is activated. In one example, the system may require identification from both an authorized service technician and the store manager in order to activate the service mode. In another example, the service technician may be required to call-in a remote security station to obtain an access code to activate the service mode. In addition, the multiple security level display system may be equipped with self-diagnostic capability, which may only permit the service mode to be activated when service is needed. Alternatively, a service panel may be provided for maintaining/servicing the multiple security level display system. Similar security measures for activating the service mode may be employed to restrict access to the service panel.

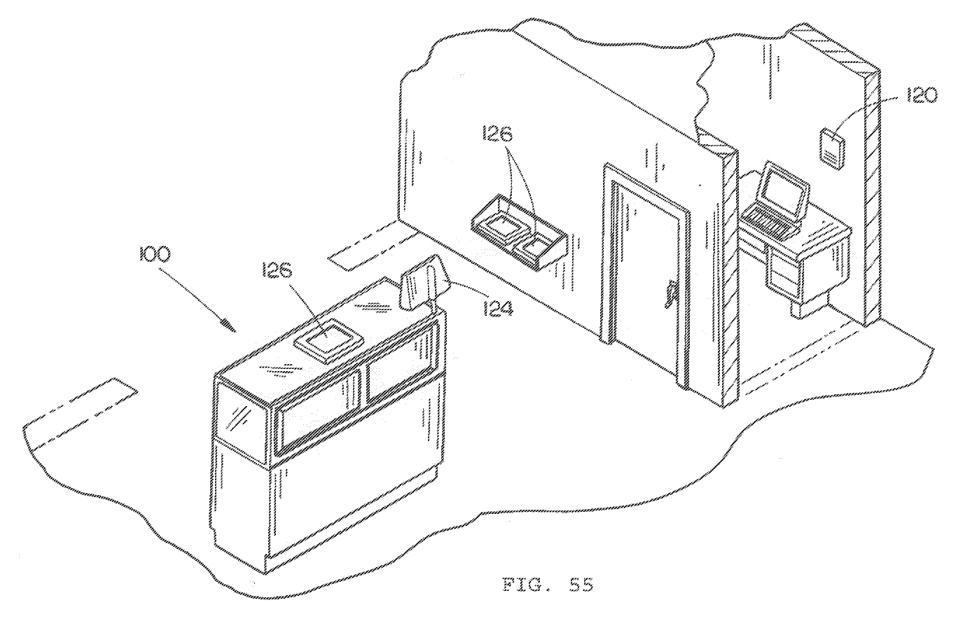

FIG. 54 shows a flow diagram illustrating steps performed by a method 200 in accordance with the present disclosure. Step 210 may store an article in a storage unit having a product exhibit device. The product exhibit device may have a storage position and a display position. Step 220 may place the article on a viewing tray. Step 230 may receive radio frequency signals at a Radio Frequency Identification (RFID) reading device communicatively coupled to the storage unit and the viewing tray. Step 240 may operate a control program in response to the RFID reading device. The control program may be configured for controlling a position of the product exhibit device, controlling access to the product exhibit device when the product exhibit device is in the display position, conducting an inventory including the at least one article, and/or monitoring a location for the at least one article where said article is at least one of in said storage unit, viewing tray, or is not in either of said storage unit or said viewing tray.

Utilizing the multiple security level display system of the present disclosure may mitigate chances of displayed items being lost or stolen. The following examples may demonstrate some operations of the multiple security level display system in an exemplary store.

For instance, the multiple security level display system may utilize a clock to keep track of the time throughout a day. Prior to the opening of the store, the items are placed on the exhibit device 110 and are securely stored in the storage position. The movable storage area cover is positioned at the closed position and the display case may not provide any direct view and/or direct access to the items. A forced entry may trigger an alert. The alert may be an audio or a visual alert. In addition, the alert may be transmitted to notify the police or security personnel (e.g., security officers working at the head office of the store).

The digital identification system 300 may refuse to respond to any request prior to the opening of the store. For example, the display system may reject a request to raise the exhibit device prior to the opening of the store regardless of the access level of the RFID key presented. Alternatively, the digital identification system 300 may be configured to grant limited access only to selected RFID keys (e.g., only respond to an RFID key assigned to a security officer or a store owner). In another example, additional security information (e.g., password and/or fingerprint) may be required in order to operate the display system prior to the opening of the store. For instance, a store manager may need to access the display case in order to rearrange the items prior to the opening of the store. The store manager may first present his RFID key to the digital identification system 300. The system may then prompt the store manager for a password, which may be entered utilizing the information display 124 (e.g., a touch screen display). The digital identification system may provide access to the display case only when the correct password is provided.

At the opening of the store, an employee (e.g., a store manager) having authority to raise the exhibit device may do so by presenting his RFID key to one of the RFID readers 120. The movable storage area cover may be moved to the open position and the exhibit device may be raised to the display position in response to the command. However, the electronic lock 122 remains locked and no direct access to the items may be provided. It is understood that not all employees may have the authority to raise the exhibit device. That is, the digital identification system 300 may reject a request from a sales associate to raise the exhibit device. The digital identification system may distinguish the different access levels based on the RFID signals receivable from the RFID keys associated with different employees.

The exhibit device may be configured to be raised automatically at the opening of the store if the presence of the store manager is detected by the digital identification system 300. However, the exhibit device may remain at the storage position prior to the opening of the store regardless of the presence of the store manager. For example, the store manager may arrive at the store a few minutes prior to the opening. The presence of the store manager may be detected, but the exhibit device may remain at the storage position until the opening of the store, and at which time the exhibit device may be raised automatically.

Similarly, the exhibit device may remain at the storage position if the presence of the store manager is not detected regardless of the time. For example, the exhibit device may remain at the storage position even after the opening of the store without the presence of the store manager. The exhibit device may be raised automatically as soon as the store manager enters the store and his presence is detected by the digital identification system 300. It is understood that the store manager may be equipped with an active RFID enabled mobile device (e.g., a pager or a portable phone) which may allow transmissions of the identification singles to the display system from a greater distance.

Access to the displayed items is monitored and controlled during the store hours. Access to an item in the display case may only be available when an RFID key with proper access permission is presented to the digital identification system 300 during the predefined time interval. For instance, a sales associate who only works in the morning shift may only access the display case during his work hours. A request to access the display case outside of his work hours may be denied by the digital identification system. In another instance, a sales associate who works in one part of the store may not have access to display systems in other parts of the store. For example, the sales associate who attends a display case for watches may not have access to another display case for diamonds. It is understood that each RFID key may be configured independently for each employee based on his/her work schedule and/or work area. Alternatively, multiple RFID keys may be configured in a batch for a group of employees with similar access permissions.

Additional security measures may be provided for controlling access to items in the display case. For example, the presence of a store manager may be required in order for a sales associate to operate the display case during store hours. For instance, if the presence of the store manager is not detected, the digital identification system 300 may refuse to respond to a sales associate's access request even if the sales associate properly presented his RFID key. In addition, the system may alert the security personnel and/or the head office of the store if an attempt to access the display case was made while the store manager is away. In another example, the system may be configured to automatically retract the exhibit device in to the storage position when the store manager leaves the store (e.g., leaves for lunch). The system may automatically raise the exhibit device in to the display position when the store manager enters the store again during store hours.

In another example, the RFID tag for each item may be associated with a security level (e.g., a more valuable item may be associated with a higher security level). When the display case is being access utilizing an RFID key associated with a lower level sales associate, the lower level sales associate may only be authorized to remove items under a certain authorized level. The lower level sales associate may be permitted to remove items above the authorized level only with the presence of the store manager. If an item with a security level above the authorized level is removed without the presence of the store manager, an alarm may be issued. A higher level sales associate, however, may be equipped with an RFID key having a different authorized level, and may be able to remove more valuable items.

The locations of the displayed items are monitored during the store hours. To mitigate the chance of an item being lost or stolen from the display case, if the item is taken out of the display case without being placed on the consumer-product interface 126 or returned to the display case for a predetermined period of time, an alarm may be issued. In addition, the RFID key utilized for accessing the display case may be recorded. For example, the digital identification system 300 may identify and/or record the RFID key presented (and therefore the employee who is associated with the RFID key), the time and duration of the access (e.g., based on the state of the electronic lock), the items removed from the display case by this employee, and the time and duration of each item outside of the display case, along with other information that may be recorded. In the event that an item is lost or stolen, the recorded data may help identify the RFID key (and the employee associated with the RFID key) utilized for accessing the display case. Furthermore, images captured by the camera may provide additional information regarding the event.

The consumer-product interface (viewing tray) may be utilized to mitigate the chance of an item being lost or stolen when an item is moved out of the display case for customer viewing. For example, if the item is moved away from the viewing tray without being returned to the display case or the consumer-product interface for a predetermined period of time, an alarm may be issued. In the event that a customer requests to briefly wear the item, the item may not be returned to the display case within the predetermined period of time. In such situations, the alarm may be configured to be delivered only to store employees without disturbing the customer. Alternatively, an alarm overriding logic for temporarily disabling the alarm may be activated by a store employee attending the customer. The recorded RFID access data (e.g., indicating who overrides the alarm) and images captured by the camera may also provide additional information regarding the event.

For additional security, more valuable items may be associated with shorter time periods before issuing the alarm. Furthermore, certain items may be required to be placed on the consumer-product interface (viewing tray) at all times (removal of such items from the viewing tray would immediately trigger the alarm). Such items and the viewing tray may be placed in the display case together, and both the items and the viewing tray may be moved out of the display case together for customer viewing. In this manner, continuous monitoring of the items may be provided.

It is understood that the alarm may be configured to indicate different levels of severity. For example, if an item is permitted to be moved away from the viewing tray for 15 seconds before returning to either the display case or the viewing tray, a low level alarm may be triggered if the item is not returned at the 16^{th} second. A mid level alarm may be triggered if the item has not been returned at the 31^{st} second, and a high level alarm may be triggered if the item still has not been returned at the 61^{st} second. Different levels of severity may be indicated utilizing different tones. In another example, different people may be notified based on different levels of severity. For instance, a low level alarm may only notify the store manager, whereas a high level alarm may notify all personnel including the police.

Emergency mode may be provided to override all current operations to position the product exhibit device into the storage position in the event of an emergency. Activating the emergency mode may mitigate the chance of an item being lost or stolen. For example, in case of a severe weather condition where all personnel are required to evacuate, the emergency mode may be activated to lower the product exhibit device into the storage position. In situations such as robberies or other hostile activities, the emergency mode may also be activated to secure the items in the storage area to mitigate the chance of break-ins. It is contemplated that additional security measures may be imposed in order to resume the operations of the display system from emergency mode to normal operation. For example, additional password and/or identification may be required in addition to a valid RFID key. In another example, a temporary lockdown may be activated and the display system may reject all operation requests during this temporary lockdown period regardless of the access levels of the RFID keys presented. In this manner, no access to the display case may be provided even if a robber obtains a valid RFID key. In addition, any forced entry may trigger the alarm.

At the closing of the store, the employee having authority to lower the exhibit device (e.g., the store manager) may do so by presenting her RFID key to one of the RFID readers 120. The exhibit device may be lowered to the display position in response to the command. The digital identification system 300 may also conduct an inventory of the items in the display case and report if any item is missing. Alternatively, the system may be configured to automatically retract the exhibit device in to the storage position at the closing.

The items may remain in the storage position for the overnight storage. For additional security, the display system may be configured to enter a lockdown mode during a user-definable lockdown period. The digital identification system 300 may reject all operations during the lockdown period. For example, if the business hours of a store are from 8:00 AM through 8:00 PM, lockdown period may be defined as 10:00 PM through 6:00 AM (of the next day). The display system may automatically enter the lockdown mode at 10:00 PM, at which point the display system may reject all operation requests regardless of the access levels of the RFID keys presented. The display system may automatically exit the lockdown mode at 6:00 AM the next day, allowing access to the display case if a proper RFID key is presented. The additional time period provided between the closing of the store and starting of the lockdown period may allow store employees to operate the display case utilizing proper RFID keys if necessary (e.g., to prepare and/or reorganize the items). Similarly, an additional time period may be provided between the ending of the lockdown period and the opening of the store.

The methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the disclosure. The accompanying method claims present elements of the various steps in a sample order, and are not necessarily meant to be limited to the specific order or hierarchy presented.

It is believed that the secure display system of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

What is claimed is:

1. A system, comprising:
a receiver for receiving a product identification signal from a product, the product identification signal for determining a location of the product;
a sensor for sensing a shopper and at least one attribute of a shopper;
a display zone defining an area in which a product and a shopper are in proximity to one another;
a safe zone defining an area between at least two of said receiver, sensor, product, or shopper defining the boundary between a product demonstration area and a theft deterrent zone; and
a display for reflecting the image of a shopper and said product and allowing a shopper to view information regarding the product at least partially selected based upon said at least one attribute of said shopper, said display configured to activate when at least one of the product and shopper are within the display zone.

3. The system of claim 1, wherein the product identification signal is transmitted by an RFID tag affixed to the product.

4. The system of claim 1, wherein the product identification signal is indicative of a specific product.

5. The system of claim 1, wherein the product identification signal is indicative of at least one characteristic selected from the group comprising a color, a decal, a design, a finish, a form factor, a hue, a material, a pattern, a shape, a size, a style, a texture, and a tint.

6. The system of claim 1, further comprising an alarm for alerting personnel when the location of the product is indicative of at least one of a lost product or a stolen product.

7. The system of claim 1, wherein the screen allows the shopper to manipulate at least one characteristic of the product selected from the group comprising a color, a decal, a design, a finish, a form factor, a hue, a material, a pattern, a shape, a size, a style, a texture, and a tint.

8. The system of claim 7, wherein the image of the shopper is combined with the image of the product on the screen.

9. The system of claim 1, wherein the screen provides the shopper with an option to request assistance from personnel.

10. The system of claim 1, wherein the screen provides the shopper with an option to purchase the product.

11. The system of claim 1, wherein the screen provides the shopper with an option to ship the product.

12. The system of claim 1, further comprising a compartment for securing a second product at least substantially similar to the first product, the second product for purchase by the shopper.

13. The system of claim 12, wherein the compartment is lockable for securing the second product.

14. The system of claim 1, further comprising a display for displaying advertisements targeted to the shopper.

15. The system of claim 1, wherein the attribute of the shopper comprises a physical characteristic of the shopper.

16. The system of claim 15, wherein the physical characteristic of the shopper comprises at least one of a body type, a complexion, an eye color, a facial shape, a gender, a hair color, a height, a skin tone, or a weight.

17. The system of claim 1, wherein the attribute of the shopper comprises a behavioral characteristic of the shopper.

18. The system of claim 17, wherein the behavioral characteristic of the shopper comprises a browsing history, a gift buying history, a promotional purchasing profile, a purchasing history, or a seasonal buying profile.

19. The system of claim 1, wherein the association between the attribute of the shopper and the product is utilized to determine an optimal placement for the product.

20. The system of claim 1, wherein the association between the attribute of the shopper and the product is utilized to determine a targeted advertisement for the shopper.
